(19) United States
(12) Patent Application Publication
(10) Pub. No.: US 2024/0216923 A1
(43) Pub. Date: Jul. 4, 2024

(54) USER INTERFACE WHICH INDUCES MACHINE OPERATOR INTERACTION AND EFFICIENCIES

(71) Applicant: FELLOWES, INC., Itasca, IL (US)

(72) Inventors: Tai Hoon Matlin, Round Lake Beach, IL (US); Jim Losser, St. Charles, IL (US)

(21) Appl. No.: 18/563,681

(22) PCT Filed: May 27, 2022
(86) PCT No.: PCT/US2022/031400

§ 371 Date: Nov. 22, 2023

Related U.S. Application Data
(60) Provisional application No. 63/194,711, filed on May 28, 2021.

(51) Int. Cl. B02C 18/00; H05B 45/20

(52) U.S. Cl. CPC B02C 18/0007; H05B 45/20

(57) ABSTRACT

A UI interface which signals to the user how to interact within an efficient manner with the machine in which the interface has been attached to or integrated within. The UI takes into consideration various machine feature based sensor inputs to gauge and signal to the operator how and when to engage with the machine to encourage the user to engage in such a way as to allow the machine to operate within its operational efficiency including but not limited to range, level, speed and energy consumption levels. The machine operator's engagement and behaviors are influenced in a human-centered way as to encourage behaviors which increase interactive control efficiencies as to reduce machine time and energy expended to process a given task, over other behaviors.

### BACKGROUND OF THE INVENTION

### Field of the Invention

The present invention relates to user interfaces, particularly for business machines which may need operator interaction when processing a given task.

### Background Art

Many machines and devices have user interfaces which provide information about system status or operation. Such interfaces may signal to the operator simple tasks of which the machine is taking on and provide communication back to the operator or user of the machine or device. By way of example, information that may be communicated to an operator of the device through the user interface may include: condition of consumables within the device, progress of a given task which the machine has been constructed to process, or the current state of the machine whether on, off, or in a sleep state.

An example of such a machine or device is a Fellowes brand paper shredder with an anti-jam feature. Such a shredder includes an indicator to let the user know when they are approaching the level of use which would induce a paper jam. The indicator in this example may include an array of LEDs which light to indicate to the user the thickness of the paper stack being inserted into the shredder for processing. The indicator goes from single color green LEDs to amber LEDs to red LEDs as the paper thickness stack approaches the maximum thickness allowed by the shredder. The LED's provide information to the operator, allowing the operator to adjust either the operation of the machine, or adjust what the operation is inputting into the machine. In the case of the paper being inserted into the machine, the LED's provide information or guidance to the user or operator to encourage the user or operator to meter the amount of paper being fed into the shredder and to prevent the operator or user from placing too thick of a stack into the shredding device.

The example shredder may also include a visual indicator such as LEDs to inform the operator as to the status of parts of the shredder, such as when the door or bin is either open or not in place, when the motor has reached a heated state, or when the unit has shut off due to the triggering of a proximity or capacitive sensor such as that used to sense a hand or other body part being too close to the entrance or feeding throat of the shredder.

Typically, these aforementioned indicators are arranged on the surface of the shredding device so that they may be viewed by the user or operator when the device is being used. However, the indicators typically are present in a manner as to make it difficult to keep track of all the indicators and therefore be of sub-optimal use to the operator during the operator's interaction with the machine.

Another machine or device in which an operator or user interacts with is a document laminator. Some examples of what might be communicated to the operator by the laminator through the user interface for such a device are the machine state such as the operator turns the unit on and the unit starts to heat up, when the proper temperature has been reached, when the laminator cooling off if cold lamination operation has been manually set or triggered, the mil thickness setting of the laminator either manually set or automatically detected, and the auto reverse of a laminated document when it gets caught within.

Similar to the shredder, the indicators used to communicate the state information to the operator may be presented to the user in a sub-optimal manner and make their use or interpretation difficult for the operator.

The above are merely examples of the types of machines and devices that may benefit from the invention disclosed herein and are not mean to limit the types of machines or devices to which the invention is applicable, or to limit the type of state or information conveyed.

### SUMMARY OF THE INVENTION

As products get smarter and integrate more inputs and sensors along with their many options, consumers today are dealing with more and more complexity when interacting with even the simplest of machines and devices. The disclosed invention endeavors to simplify the operator experience and provide improved conveyance of information to the operator even when interacting with a more complex machine while encouraging the operator to be as efficient as possible. Such efforts may result to reduce the time they spend interacting with the machine to execute the task at hand and therefore expending less power and consuming less energy as well.

Typically, the machines for office and home use such as laminators, air purifiers, and shredders have many locations on the machine in which the operator needs to observe to understand the machine's status, availability, operation condition, consumable level and so on. The disclosed invention presents the operator a unified user interface (UI) where a single point UI simplifies in an expressive way, the machine's complex operations, status, availability, operation condition, consumable levels, or other parameters as to enhance the user's experience (UX) while improving their interactive involvement with the machine as they initiate and complete the given task in which the machine was designed for.

The disclosed invention, User Interface which Induces Machine Operator Interaction and Efficiencies, in its simplest embodiment can be implemented by the use of a plurality of LEDs, ideally RGB LEDs and in a more complex embodiment, an OLED screen. Other displays may also be used to convey information to the operator or user. In some embodiments, the UI may function in such a way as to guide the operator into interacting with the device in the most efficient manner so as to have the device operate or complete its task efficiently. In some embodiments, this may be accomplished by giving the operator a sensory input or communication or trigger such as visually via an LED or other light device of display or additionally and optionally, a speaker for auditory communication, or additionally and optionally a mechanized motion, as to encourage and signal the user to perform a function in a predetermined and controlled manner.

In some embodiments the communication of information to the user may be accomplished by using humanistic techniques in the UI feedback and communications process to engage the operator. For example, the utilization of the LED output levels, patterns and colors as well as the animated transitions with and without the addition of sounds, haptics or physically felt actions may be utilized in a manner to effectively emulate human centric rhythms, cycles, and logical sense-based processing. These methods can be utilized in a manner as to engage the operator on both conscious and subconscious levels improving the operator's acceptance and understanding of complex machine functions and outputs due to the intrinsically natural methodology utilized and hereby disclosed.

The following are exemplifications of the disclosed invention in an office or consumer business type machine. One skilled in the art will recognize that such examples are only examples and not limitations on the scope of the disclosed invention. Some global power requirements require certain types of office machines go into a sleep state when not being used. In some embodiments the disclosed invention may optionally incorporate a proximity sensing device or sensor such as a capacitance sensing arrangement to gage the proximity of the operator or any other person or animal relative to the machine which can be used to signal to the operator, that this particular machine is sensitive, tuned to them and ready to be engaged.

Such a feature could be implemented where the controller of the machine receives an input signal from the capacitance sensing arrangement or sensor and upon reaching a particular triggering threshold, would then signal the machine to wake up from its sleep state. This wake-up sequence of the machine would be communicated though a possible UI array in a way as to let the operator know they have now engaged the machine by approaching within its activating proximity zone and the machine is now ready to be engaged further. The machine through the UI could further trigger a communication in which to encourage the operator to engage with it in the next sequential action through a series of animated LED light sequences. This automatic proximity sensed activation is much more convenient for the operator of these types of machines since the nature of the tasks involved, the operator typically has their hands full and therefor the auto-awake and communications action bypasses the need for the operator to manually touch a button to engage and trigger the machine to wake up from its sleep state. With the UI as utilized in this disclosed application, the user knows the machine's change of state, is encouraged to further engage the machine by the signaling the next sequential action needed by the machine while being given seemingly positive feedback thereby creating a UX communications loop engaging both the machine and the operator interactively by way of the UI.

A category of business type machines such as shredders have sensors within the paper feed throat, which typically comprise of some sort of mechanical or IR based sensor to detect paper or other material in the feed throat. Other more feature rich shredding machines such as Fellowes 79Ci 100% Jam Proof Shredder have a more complex sensor array including a sensor approximate to the feed throat which may detect a potential feed issue. In response to a signal from the sensor, the controller may then stop the shredder or will not let it operate. The controller may send a signal to cause the illumination of a corresponding icon in the warning icon area. Similarly, an interlock door open switch, an overheat sensor, or a bin full sensor may cause the controller to illuminate a backlit icon residing in the warning icon area located on top of the machine.

Similarly other functions or malfunctions of the shredder may be communicated to the user or operator. For example, with the proper sensors installed, the feed throat of the shredder may detect not just the inserting of paper, but the actual thickness of the stack of paper inserted into the feed throat. The shredder communicates to the user the thickness of the stack of paper inserted into the throat by a LED bar which has one green, several amber and a red LED. Such information or display communicates to the operator or user how close one is getting to a jam threshold. In practice, this LED bar is located at another location other than the previously described warning icons. Thus, operation information or more generally, information that is communicated to the user may appear at various and different locations on the machine creating a need for the operator or user to monitor or scan different areas of the machine. A more ergonomic and improved solution, as presented by the invention disclosed herein, is to present the information in one location on the machine.

As an exemplary embodiment of the disclosed invention when applied to the aforementioned shredder machines, would bring the UI to a more localized area as to give the operator a single focal zone of observation and interaction which in turn allows the operator to more easily perceive the information conveyed by the UI by way of a quick and single glance, and to understand the machine's current status. The disclosed embodiment would differ from the prior art as it does not only warn the operator of a machine condition, such as a paper jam, the invention disclosed herein would function to communicate to the operator using a human centered approach as a way to encourage the operator to alter their interactive behavior; such as to feed significantly more than the operationally safe minimum which in turn allows the machine to operate more efficiently in its power band while shortening the operators interaction time with the machine to process the task at hand.

For example, in an embodiment of a shredder, when the desired amount of paper is inserted within the desired feeding rate by the operator, the UI may emit a pleasing output, utilizing visual, audible, or haptic means as to encourage and prolong this optimal level of operator action as they continue to interact with the machine to process the task at hand. By utilizing the disclosed means, the operator would therefore be encouraged to insert more paper per pass than they may typically insert into a shredder and at a higher frequency or rate than typically executed, yet still remain below the machine's jam threshold as compared to using the same machine in absence of the disclosed invention. The UI provides guidance and feedback to the operator so that the operator may interact with the machine to allow the machine to act in an efficient manner. As the operator nears the established jam threshold, the UI array would change as to communicate the limit approaching. This warning communication could be emoted utilizing one or more visual, audio and haptic signaling in a manner to encourage the operator of the machine to reduce the paper stack thickness during the next insertion cycle.

In some embodiments, the UI may integrate other status information or localize information, such as the waste bin status. The waste bin status is one of particular interest since research has shown that a sudden stop due to bin full causes frustration as well as jams. The UI can lesson that frustration by showing the bin level during pauses as to warn the operator through the localized UI that they are approaching a stop condition and to prepare for that stop. This warning allows the user to optionally pause their processing session so they can prioritize which items should be processed to ensure the completion of the most critical items, prior to the forced machine stop. Once the bin has been emptied and placed back into the machine, the machine's bin full condition threshold would then be reset.

Similarly, other stop conditional warnings could be integrated into the UI as well, such as motor overheat. Similarly, the motor temperature or other motor information such as run time could be monitored and as the motor approaches a cut off condition or as the performance deteriorates over time, the UI may convey to the operator an impending stop condition or an adjustment for performance is approaching and communicate these changes in condition so as to allow the operator to prioritize their items to be processed before the machine comes to a forced stop state.

In some embodiments the UI LED bar can be configured to give a countdown condition by varying the bar length, color and intensity, or any combination of those indicators to create an animated signal to let the operator know when to expect the machine function to resume. With such communication or signals to the operator, the UI may engage and incentivize the operator's paper feed timing and stack thickness in a manner encouraging and engaging the operator to respond to the machine's UI in such a way as to remain in the optimal machine and operator's efficiency band as much as possible. This allows for the ideal efficiencies to be reached as the operator processes the job at hand, as quickly as possible using the least amount of time and energy to process the task.

For laminating and similar type processing machines such as pouch laminators, LED and backlit icons are located in many different areas of a typical prior art machine and light up to communicate information regarding machine heat up, readiness (temperature met), cold or hot mode, pouch thickness setting, reverse on jam to name some examples. One skilled in the art will recognize other examples. Typically, in operation the laminator when turned on goes through a heat-up cycle and the machine communicates the heating process is ongoing by flashing an LED and when the proper temperature is reached, the light is continuously on to denote the machine is ready for a pouch to be inserted into the machine. Once the pouch is inserted, some machines regulate speed of processing depending on the thickness of the item inserted and the pouch thickness. The thicker the inserted item and pouch thickness chosen, the slower the unit laminates. As the laminated pouch progresses through the machine, typically the operator or user observes the progress by looking for the leading edge to emerge from the machine to see the rate the machine is processing the item.

However, in some instances the process does not proceed or progress as intended. Sometimes the item does not process properly through the machine, which is considered a jam. Some machines notify that a jam has occurred by utilizing a sensor to detect a point in the machine where the item should be sensed during the processing progression. If the sensor does not detect the item, a jam light or icon would be triggered by the machine to let the operator know of the warning condition. Other machines not only trigger the warning condition, they may auto reverse in attempts to alleviate the jam or simply trigger the warning light to let the operator know they need to act to manually unjam the machine.

Lamination machines such as those discussed in this application may include a UI embodiment to unifying the main communications elements to a more centralized UI zone to allow the user to have a focal point or area in which to receive the machine's communications. This collection or centralization of the information in turn facilitates the operator's ability to assess the machine condition with one simple glance.

The disclosed UI in its simplest form could utilize a plurality of LEDs, ideally RGB LEDs. During the warm-up cycle, the LEDs may go through a predetermined sequence of color changes as to emulate the machine's actions. These actions may be sequential in a way as to convey motion as well since the internal workings of the machine have been activated. After the warmup cycle is complete with the machine warming up to the required temperature for proper lamination and once the optimal temperature is met, the LEDs of the improved UI may then signal to the user along with an optional audio tone, communication, signal or motion, to let the operator know the unit is ready to accept an article for lamination. Once the operator feeds the article into the entrance throat of the machine, an optional thickness sensor may determine the thickness of the article and a corresponding signal is sent to the controller which determines by way of preprogrammed set of thresholds, the motor speed, and/or the thermal temperature in which to process the article through the machine.

In some embodiments the machine in reaction to the operator inserting into the machine the item within a lamination pouch, can optionally express the thickness sensed in representative form on the LED light bar array. Typically, there are three main pouch thicknesses utilized in office laminators, three, five and ten millimeters, so the light bar or other UI may then send a predetermined output to correspond with the operator's inserting action. The thickness sensor may sense the thickness of the pouch including the item within the pouch and output a signal to the controller. As the inserted item continues to the first set of feed rollers, the roller speed may be adjusted by the controller based on the output of the thickness sensor and automatically adjust the rate of feed or rate of the rollers. In embodiments without a thickness sensor, the laminator may allow for some manual settings and adjustments. The thicker pouches take longer to process through the machines correctly than the thinner pouches.

In view of the previously mentioned reasons and acknowledge by operators of these machines, jams can and do occur. The UI of the present invention may decrease such jams. Frequently observed during usage studies, operators are looking and waiting for the machine to process and exit the inserted item since the visual cue of the leading edge of the inserted item exiting the machine signals a successful trip through the laminator without a jam. To avoid this type of behavior and to alleviate the need to wait anxiously while the machine is processing the item, the present invention UI's LED array can be configured to show the represented progress of the item being processed through the machine. Thus, the operator may focus on the UI, which may provide the operator with information regarding machine status in addition to the progress of the lamination process.

In some embodiments, the progress of the lamination process can be calculated by taking the entrance sensor being triggered, and at the minimum, the speed of the process rollers, and the UI LEDs illuminated to represent the speed or movement of the process rollers. Ideally, an additional exit sensor or a sequence of sensors would aid in the proper detection of a jam if and when the sequential sensor or exit sensor does not detect the inserted item within the calculated expected time threshold. If a jam occurs during the processing of the item through the unit, the UI may indicate the jam as to ensure the operator reacts accordingly. If the machine has an auto reverse feature, the UI may show the machine is auto reversing the jammed pouch back out the entrance and accordingly during the process, the UI will signal the jam to the operator, and then the reversal of direction and the progress of the reversed item back through the machine, to ensure the operator understands the machine is reacting to a jam state and its progress of reversing to unjam itself. Such a process may be indicated on the UI by the LEDs illuminating in a reverse sequence or a change in color, as an example. One skilled in the art will recognize there are many ways to communicate information to the operator via a collection or series of LEDs or other type of display and those mentioned herein are merely examples.

If the machine is a manual reverse machine the UI may indicate and communicate to the operator that the operator may need to put the machine in a reverse state as to release the jammed document from the machine and the reverse tracking progress would be indicated by the UI. Of note, some lower cost machines do not have a reversing feature; a drive gear release lever may need to be engaged to allow the jammed document to be pulled out of the machine manually. In the stated cases, the machine through the UI would indicate to the operator the state of the progress of the material through the machine, a jam occurrence if and when a jam occurs, and when either manual or automatic means has been initiated in the attempts to release the jammed item and the progress of the reversed items back out of the machine.

In some embodiments when more accuracy of tracking the progress through the machine is desired, optional additional sensors, such as IR sensors, can be utilized within and along the processing path of the machine. When the sensor's triggering threshold is reached, the controller may then trigger the proper LED or LEDs within the UI to communicate progress much more accurately than just a timer-based system. These additional sensor triggers are taken into consideration to allow the controller within the machine to make the adjustments needed to improve the representative positioning of the inserted item as it progresses through the machine. These real-time adjustments can also be utilized to ensure the roller speeds are correctly functioning. As these machines use two, four, six and sometimes eight or more rollers, there is a need when changing speeds, to ensure the rollers are working in unison to safeguard the inserted item comes out properly, and within acceptable quality standards, and as flat as possible.

We are disclosing herein a method and apparatus in which the progress of the lamination pouch going through the machine and passing sensor elements allows for a determination of timing which can then be compared against established thresholds. Additionally, the method and apparatus may take into account other sensors, information, or data such as thermal sensor data to determine if the roller speeds and temperatures are within a defined parameter or if adjustments need to be made to either roller speed, or processing temperature, or both.

In some embodiments, alternative sensors can be attached to the rollers such as, but not limited to, hall sensor to determine roller speed and additionally, each roller set can be individually motorized for even more control of the lamination process. Additional sensor elements may be optionally placed within the entrance and exit trays of the laminator, and in between the roller pairs as to sense the item's lamination progress from start to finish. The entrance and exit trays may be an integral element, an additional user assembled part, or can fold or slide out from the unit housing. For an exemplified embodiment, the laminator may include entrance and exit trays which fold down individually or in unison by a linkage assembly with and without a dampening slow open feature with an interlock switch to ensure the machine is not in operational state when the tray doors are closed. Additionally, the fold down tray/s can have an extending member/s which by a linkage element can operate in unison or without the linking element, individually as to create a more supportive and self-centering entrance and exit tray extender even when the entrance and exits are located off the centerline of the machine. The laminator may include switches or sensors that sense the position of the trays and communicate the position to the controller. This information may also be included in the information displayed by the UI.

Furthermore, since roller pressure ensures proper lamination by pressing the heated assembly together as it processes through the rollers, the adjustment action/s can incorporate a cam lever, a screw arrangement, with and without springs, or any other means to engage the rollers to adjust the assembly pressure of an upper and lower roller set. The pressing force can be manually adjusted, or remotely by motor, or solenoid, or pneumatic/hydraulic means and then therefor, an automatic means can be utilized by way of the controller to adjust the pressing and releasing forces applied to the given roller sets as to ensure proper lamination. This adjustment action can be sensed with sensors and communicated to the controller which signals and actuates any adjustments if needed. The position or adjustment information for the rollers may be included in the information displayed on the UI.

Additionally, we are disclosing an anti-wraparound feature or elements which may include a plurality of elongated radiused elements assembled in such a way as to be inserted perpendicularly or otherwise through the elastomeric layer of the processing roller of a laminator. The placement of elongated radiused elements along the feed and/or processing and/or exit path of the machine do not allow the inserted item to be laminated to wrap upwards or downwards and around the roller element even when the roller element has adhesive residue from use. The seating depth of the elongated radiused members is determined by the elastomeric layers ability to compress and seal each of the slit openings in totality along the contacting compression zone of the roller pairs in such a manner as to not create a noticeable mark on the item being processed through the compressed roller assembly. It is preferable that the elongated radiused members conduct heat by contact or proximity means to the heated rollers which induces the slit opening to properly seal temporarily when compressed. This is due to the elastomeric layer being more pliable when heated versus having a cooling heat sink effect if the elongated radiused members were not made of a heat conductive material.

Other features such as a cleaning and/or maintenance cycles and their corresponding UI indication can be incorporated into the aforementioned and similar types of machines having components which can get worn, deformed, dirty, or full of the material it is processing as to impede the proper function or processing of the material through the machine. When a part, component, and/or consumable element needs maintenance or replacement, a signal indicator can be actuated to let the operator know through the use of the UI along with possible audio and haptic indicator means to signal a maintenance cycle is needed, approaching, or is urgent. In some cases, when the maintenance cycle is complete, the indicator can be automatically cleared by the use of a sensor/s which recognize when the maintenance cycle has been accomplished, otherwise a manual reset can be utilized to reset the indicator cycle.

In the embodiment of a shredder, the maintenance indication may be triggered by a need to lubricate the cutters of the shredder. As the shredder is used over time, periodically the cutters need oiling to reduce premature wear. The UI indicator of the present invention may indicate to the operator the countdown, or percentage of life, or time to the needed oiling cycle. The countdown could be as simple as a timer based on the running time of the shredder motor. Optionally for increased accuracy, the input from the thickness sensor could be added as an additional data point to track wear and tear on the machine and as a means to create more accurate thresholds. Once the predetermined maintenance threshold has been reached, the thickness sensor (which can recognize the initial insertion and a pattern of intentionally varying thicknesses) or IR sensor (which can recognize the initial insertion and an intentional graphic element or pattern) or both can be utilized to detect an oil maintenance sheet being introduced into the shredder throat and after the detected oil maintenance sheet clears the unit, the controller may then execute a command to reset the indicator as to start another cycle based on the preset established thresholds.

In another embodiment, as in a laminator machine, the heated rollers over time get adhesive on the surfaces of the roller and that adhesive needs to be periodically removed. Similarly to the aforementioned shredder, a maintenance operation is triggered and similar to the shredder a maintenance sheet which removes the excess adhesive can be introduced into the laminator in which the laminator, by way of sensors such as an IR sensor to detect a marking, or pattern on the cleaning sheet which would allow bi or multi directional insertion, and/or by way of the thickness sensor, varying thickness or pattern of thicknesses as to trigger a threshold value/s which the machine recognizes as the maintenance sheet and therefor when the sheet clears the laminator, the clean cycle communications is then automatically reset. If an automatic means is not integrated or if a non-authorized clean sheet is utilized, a manual over-ride can be accessed by the operator as to clear the signal and to reset the threshold cycle.

In some embodiments, variable processing speeds and functions can be controlled and communicated by way of the UI to illustrate speed, and in such embodiments the UI progress metering function and devices such as LED's used to communicate information to the user the machine may speed up, or slowdown. Such speed may be in reaction to the operators preferred setting/s such as choosing quick draft quality versus a longer higher quality lamination cycle. If an automatically determined setting is chosen and a change in state is actuated by the machine due to a preprogrammed threshold being reached, the UI may then communicate that change to the user by slowing or increasing the speed of the signaling on the UI communications means or LEDs or other display as to ensure the operator understands the machine state is changing. Additionally, the progress metering function shows the progress of the inserted item going through the machine as to let the operator see the slowed or increased processing speed. In some embodiments the operator may choose adjustments or options such as size cut in the case of shredders (security level), or speed versus quality (clarity) of the laminated end product for laminators, and to communicate these adjustments, colors and/or emitted intensity and/or patterns could be utilized by the UI interface as well as additional auditory and/or mechanical signaling. Similarly, adjustments can be communicated by the disclosed UI for any other similar type of machines.

With the unique ability to communicate machine state, changes and operational adjustments readily, quickly and easily, the operator's comprehension of the machine's actions and state are improved due to the unique interactive emotive nature of the UI. The operator of the machine with the disclosed UI, will see the immediate state changes and adjustments to the machine due to this constant loop of interactive, emotive, and encouraging communications improving the UX. Examples where the improved interactive communications methods add efficiency for the operator as to utilize the improved feature as much as possible is dependent on the UI's ability to let the operator know when the machine has concluded its pre-phase and is now ready to process. A heating core arrangement or a laminator may utilize a heating source such as a quartz heater, and/or other similar means which radiates heat. We are disclosing a heating core utilizing both direct and indirect radiation, or conductive and emissive means, as to purposefully create a controlled preheat zone in the laminator prior to the main heated rollers, which in some embodiments are heated by the same main heating source without having to utilize an additional set of heated rollers. This improved heating core arrangement, with a purposefully designed preheat zone, allows for improved heat-up times and operational processing times when laminating. In some embodiments the heating core includes an area and rollers before the heating rollers. This improvement becomes even more useful if the operator understands the machine is in heat-up or sometimes cool down phases and when the machine has reached the proper operational temperature. This is accomplished by encouraging the operator to immediately insert the item to be processed when the machine is ready after the initiation process and/or during the standard operational process through the use of the disclosed emotive communications emulating from the UI.

The disclosed UI outputs not only give positive feedback when the operator and the machine reach these efficiency criterions, by utilizing and mimicking certain human rhythms, such as breathing, logical thinking behavior processes and patterns to create a more humanistic approach of intercommunications vs. the typical binary logic of machine functions, allows the operator to innately understand the machine's operational status and how to interact to with it more naturally even when they approach the machine for the first time. The UI is designed to naturally communicate to the operator certain actions, or certain adjustments needed to be taken on by the operator themselves as to hit optimized operational criterions, levels, and/or zones, which in turn are compared against sensor inputs originating from the machine's mechanoreceptors, thermoreceptors, photoreceptors, electroreceptors and any other similar machine sensor which would then be processed through the controller prior to the machine communications through the UI interface back to the operator. Since these interactive actions, inputs and communications seemingly are more natural, as well as located logically, the operator observational focus is centered and simplified, allowing them to be more open to adjusting their behavior to match the actions needed by the machine in the efforts to align both machine and operator actions to maximize efficiencies. This type of machine and human centered UI communications allows for higher levels of efficiency in a more readily acceptable natural way which uniquely unifies and aligns both the machine's design intentions and the operator's objectives to create a new and improved UX.

As disclosed herein and illustrated, the invention can be applied to a wide array of operator engaged processing machines and appliances and should not be limiting by the disclosed embodiments within this document in any way. To the contrary, the present disclosure is intended to encompass all modifications, alterations, substitutions within the spirit and scope of the disclosed inventive features.

In one form, the invention is directed to a shredder having an input entrance for inputting material for shredding, a bin for receiving shredded material, a machine status display located proximate to the input entrance, a thickness sensor to sense the thickness of material placed in the input entrance, a bin level sensor, a motor temperature sensor, and a controller for receiving inputs from the thickness sensor, the bin level sensor, and the motor temperature sensor. The controller is in communication with the status display. The controller determines the optimal thickness of material for placement in the input entrance. The status display communicates whether the material placed in the input tray is of an optimal thickness for shredding.

In one form, the display communicates a first signal to indicate the material is of a less than optimal thickness, communicates a second signal to indicate the material is of an optimal thickness, and communicates a third signal to indicate the material is in excess of an optimal thickness.

In one form, the display is an array of LEDs arranged parallel to the input entrance. The display pulses to indicate the material is of optimal thickness.

In one form, the display pulses to communicate the shedder is operating at optimal efficiency.

In one form, the display is an array of LEDs arranged in parallel to the input entrance. The LEDs light sequentially in sequences to communicate to the operator whether the material is of an optimal thickness.

In one form, the display lights an increasing number of LEDs as the thickness of material increases to the optimal thickness.

In one form, the shredder has a proximity sensor to sense when an operator is in proximity of the shredder. The proximity sensor communicates with the controller. The controller wakes the shredder for operation when an operator is sensed by the proximity sensor. The controller communicates with the display to communicate with the operator that the shredder is ready for receiving material.

In one form, the controller communicates with the display to signal to the operator to reduce the thickness of material when the motor temperature sensor exceeds a threshold level.

In one form, the invention is directed to a shedder for shredding material. The shredder includes an input slot for inputting material into the shredder, a plurality of sensors, a controller for receiving inputs from the sensors, and a display in communication with the controller. The display conveys information on the shredder status to an operator. The sensors include a proximity sensor, a bin level sensor, a motor temperature sensor, and a thickness sensor. The controller evaluates the inputs from the plurality of sensors. The display displays a first signal on the display when an operator is in proximity to the shredder. The display displays a first sequence of signals when a less than optimal thickness of material is placed in the input slot, a second sequence of signals when an optimal thickness of material is placed in the input slot, and a third sequence of signals when material of a thickness greater than an optimal thickness is placed in the input slot.

In one form, the display is a plurality of LEDs positioned parallel to the input slot. The first sequence of signals is a progression of lighted LEDs. The number of lighted LEDs increases as the thickness of material increases.

In one form, the second sequence of signals is a pulsing of lighted LEDs.

In one form, the third sequence of signals is a progression of lighted LEDs changing from a first color to a second color.

In one form, the first signal is a lighted LED. The LED is lit in a third color.

In one form, the invention is directed to a shedder for shredding material. The shredder includes an input slot for inputting material into the shredder, a plurality of sensors, a controller for receiving inputs from the sensors, and a display in communication with the controller. The display conveys information on the shredder status to an operator. The sensors include a proximity sensor, a bin level sensor, a motor temperature sensor, and a thickness sensor. The controller evaluates the inputs from the plurality of sensors. The controller determines display patterns for the display to convey machine state information to an operator. The display patterns include a first display pattern to communicate the shredder is on and ready for input, a second display pattern to communicate the shredder can accept an increase in material in the input slot, a third display pattern to communicate the shredder is receiving an optimal amount of material in the input slot, and a fourth display pattern to communicate the shredder is approaching a shut-down condition.

In one form, the display patterns are displayed on an LED display located parallel and proximate to the feed slot. The LED display includes a plurality of colors.

In one form, the first display pattern includes a plurality of LEDs lighting in the color blue in an increasing number. The pattern repeats when the number reaches five.

In one form, the second display pattern includes a plurality of lighted segments. The number of segments lit increases in number as an amount of material placed in the input slot nears the optimal amount of material.

In one form, the third display pattern includes a plurality of lighted segments. The lighted segments pulse.

In one form, the controller evaluates inputs from the motor temperature sensor and the thickness sensor to select the display pattern to display.

In one form, the controller evaluates inputs from the bin level sensor, the thickness sensor, and the motor temperature sensor to determine an optimal thickness of material the shredder should accept.

### BRIEF DESCRIPTION OF THE DRAWINGS

FIG. 1 is a three quarters view of a prior art business machine, a paper shredder and its user interface configuration.

FIG. 2 is a three quarters view of a prior art business machine, a document laminator and its user interface configuration.

FIG. 3 is a simplified operational block diagram of the prior art business machine's inputs and outputs.

FIG. 4 is a simplified operational block diagram of the newly disclosed invention User Interface which Induces Machine Operator Interaction and Efficiencies as applied to a business machines inputs and outputs.

FIG. 5 is a simplified view of the interactive portion of a paper shredder with the disclosed invention, as applied to a business machine and embodied within.

FIG. 6 is a simplified view of the interactive portion of a document laminator with the disclosed invention, as applied to a business machine and embodied within.

FIG. 7 is an interior underside view of the interactive portion of paper shredder with the disclosed invention embodied within.

FIG. 8 is a flowchart representing the decision tree actions of the disclosed invention as embodied in a paper shredder.

FIG. 9 is a representative chart in which the disclosed invention in the embodiment a paper shredder illustrating RGB LEDs positions and actions in a chart form.

FIG. 10 is a simplified sequential illustration of the interactive portion of a paper shredder with the disclosed invention as applied and the interactive UI communication of the machine upon proximity detection from a machine sleep state.

FIG. 11A is a simplified sequential illustration of the interactive portion of a paper shredder with the disclosed invention as applied and UI indicator communication of the machine's motor temperature and waste bin status levels.

FIG. 11B is a simplified sequential illustration of the interactive portion of a paper shredder with the disclosed invention as applied and UI indicator communication of the machine's motor temperature and waste bin status levels as the temperature and bin levels increase from those of FIG. 11A.

FIG. 11C is a simplified sequential illustration of the interactive portion of a paper shredder with the disclosed invention as applied and UI indicator communication of the machine's motor temperature and waste bin status levels as the temperature and bin levels increase from those of FIG. 11B.

FIG. 11D is a simplified sequential illustration of the interactive portion of a paper shredder with the disclosed invention as applied and UI indicator communication of the machine's motor temperature and waste bin status levels as the temperature and bin levels increase from those of FIG. 11C.

FIG. 12 is a simplified sequential illustration of the interactive portion of a paper shredder with the disclosed invention as applied and UI indicator communication of the machine's status when the proximity sensor adjacent the paper insertion entrance is activated.

FIG. 13A is a simplified sequential illustration of the interactive portion of a paper shredder with the disclosed invention as applied and UI indicator communication of the machine's status when the thickness sensor is engaged.

FIG. 13B is a simplified sequential illustration of the interactive portion of a paper shredder with the disclosed invention as applied and UI indicator communication of the machine's status when the thickness sensor is engaged as the amount of material the shedder may accept is increased from that of FIG. 13A and approaches an optimal amount.

FIG. 13C is a simplified sequential illustration of the interactive portion of a paper shredder with the disclosed invention as applied and UI indicator communication of the machine's status when the thickness sensor is engaged as the amount of material the shedder may accept is increased from that of FIG. 13B and approaches an optimal amount.

FIG. 13D is a simplified sequential illustration of the interactive portion of a paper shredder with the disclosed invention as applied and UI indicator communication of the machine's status when the thickness sensor is engaged as the amount of material the shedder may accept is increased from that of FIG. 13C and approaches an optimal amount.

FIG. 14A is a simplified sequential illustration of the interactive portion of a paper shredder with the disclosed invention as applied and a continuation of the sequence from the previous FIGS. 13A-D, showing the display when the shredder is processing an optimal amount of material.

FIG. 14B is a simplified sequential illustration of the interactive portion of a paper shredder with the disclosed invention as applied and UI indicator communication of the machine's status when the thickness sensor is engaged as the amount of material the shedder may accept is increased from that of FIG. 14A and approaches a maximum amount.

FIG. 14C is a simplified sequential illustration of the interactive portion of a paper shredder with the disclosed invention as applied and UI indicator communication of the machine's status when the thickness sensor is engaged as the amount of material the shedder may accept is increased from that of FIG. 14B and approaches a maximum amount.

FIG. 14D is a simplified sequential illustration of the interactive portion of a paper shredder with the disclosed invention as applied and UI indicator communication of the machine's status when the thickness sensor is engaged as the amount of material the shedder may accept is increased from that of FIG. 14C and approaches a maximum amount.

FIG. 15A is a simplified sequential illustration of the interactive portion of a paper shredder with the disclosed invention as applied and a continuation of the sequence from FIG. 14.

FIG. 15 B is a simplified sequential illustration of the interactive portion of a paper shredder with the disclosed invention as applied and UI indicator communication of the machine's status when the thickness sensor is engaged as the amount of material the shedder may accept is increased from that of FIG. 15A and approaches a maximum amount.

FIG. 15C is a simplified sequential illustration of the interactive portion of a paper shredder with the disclosed invention as applied and UI indicator communication of the machine's status when the thickness sensor is engaged as the amount of material the shedder may accept is increased from that of FIG. 15B and approaches a maximum amount.

FIG. 15D is a simplified sequential illustration of the interactive portion of a paper shredder with the disclosed invention as applied and UI indicator communication of the machine's status when the thickness sensor is engaged as the amount of material the shedder may accept is increased from that of FIG. 15C and approaches a maximum amount.

FIG. 15E is a simplified sequential illustration of the interactive portion of a paper shredder with the disclosed invention as applied and UI indicator communication of the machine's status when the thickness sensor is engaged as the amount of material the shedder may accept is increased from that of FIG. 15D and approaches a maximum amount.

FIG. 16 is a flowchart representing the decision tree actions of the disclosed invention as embodied in a laminator.

FIG. 17 is a simplified chart representing the interactive UI status indicator of a document laminator with the disclosed invention embodied within.

FIG. 18 is a simplified cross-sectional view of a prior art business machine, a document laminator, illustrating the lamination process of the item inserted into the machine and its progression through the machine.

FIG. 19 is a simplified cross-sectional view of a document laminator with the disclosed improved heating core embodied within illustrating the lamination process of the item inserted into the machine and its progression through the machine until completion.

FIG. 20 is a simplified partial machine cross-sectional view of a document laminator with the disclosed anti-wrap feature embodied within.

FIG. 21 is a partial front elevational view of laminator heat rollers having self-healing channels for anti-wrapping wires.

FIG. 22 is a partial side cross-sectional view of laminator heat rollers having self-healing channels for anti-wrapping wires.

FIG. 23 is a perspective view of laminator feed rollers, heat rollers, and exit rollers including aligned channels in the rollers and anti-wrapping wires.

FIG. 24 is a side view of the roller and wire arrangement of FIG. 23.

FIG. 25 is a front elevational view of laminator feed rollers, heat rollers, and exit rollers including aligned channels in the rollers and anti-wrapping wires.

FIG. 26 is a side cross-sectional view of the arrangement of FIG. 25.

FIG. 27 is a simplified illustration of a document laminator feature disclosing a uniquely functioning cleaning feature and UI interface.

FIG. 28 is a flow chart of the logic for operation of the cleaning of a laminator of the present invention.

FIG. 29 is a cleaning sheet including indicia and diagonal code.

### DETAILED DESCRIPTION OF THE PREFERRED EMBODIMENT

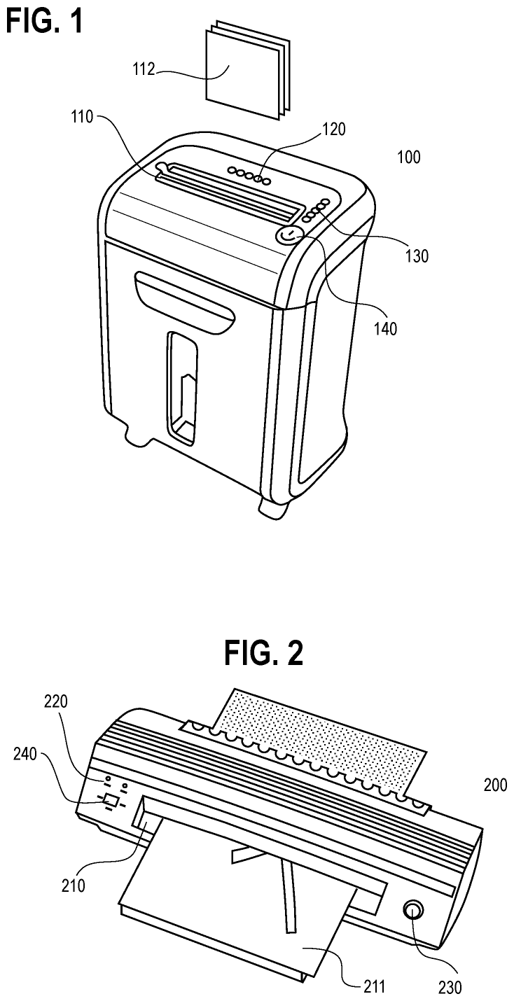

With reference to the Figures, the invention can be applied or embodied in a number of business machines. Throughout this disclosure, one skilled in the art will recognize that the terms user and operator may be used interchangeably. FIG. 1 is a three quarters view of a prior art business machine, a paper shredder. Paper shredder 100 has operator inputs including the power, forward and reverse control elements 140, located within the lower right quadrant of the shredder's upper face when facing the unit. The operator input controls are utilized to power up, and/or wake up the shredder from sleep state, and/or forward or reverse the paper stack 112 once the stack has been inserted into the shredder by way of the operator input paper entrance 110. Backlit LED warning icons 120 are located within the top upper centered quadrant location of the shredder's upper face and need to be referenced during the operation of the shredder as does thickness sensor LED indicator 130 which is located within the upper right quadrant of the shredder's upper face. The thickness indicator lets an operator or user know if the paper stack 112, being fed into the operator input entrance 110, is too thick to allow the shredder to process the stack, or in the alternate of the paper stack is within the acceptable parameters, the motor operates and the determined thickness value of the stack of paper being processes is projected by the thickness sensor LED indicator 130. In this prior art shredder 100 a multitude of locations need to be accessed and observed to understand the machines functionality and to interact with the machine during its operation cycles.

FIG. 2 is a three quarters view of a prior art business machine, a document laminator. Document laminator 200 has operator inputs including the power control element 240, located within the lower left quadrant of the unit's forward face, when approaching the unit, and a manual pouch thickness selector dial 230 located within the lower right quadrant of the unit's forward face. The operator input controls, including the power control element 240 are utilized to initiate the unit's heat up cycle. LED machine status indicators 220 indicate when the unit has reached optimal temperature. When the optimal temperature is reached, the document to be processed within lamination pouch 211 is inserted into document operator input entrance 210. A multitude of locations need to be accessed and observed to understand the machines functionality and to interact with the machine during its operation cycles.

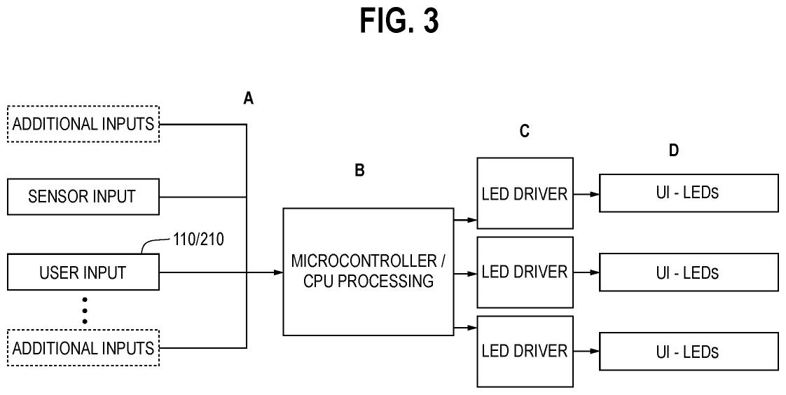

FIG. 3 is a simplified operational block diagram of the prior art business machine's inputs and outputs. Operator input 110, and operator input 210 designate where the operator inserts the item to be processed by the machine. The multitude of inputs, including operator inputs and sensor inputs (block A) communicate to Microcontroller/CPU (block B) and depending on the firmware and designated thresholds, communicates to the multiple LED drivers (block C) located in multiple locations which in turn drive the LED UI status indicators (block D) located in multiple locations.

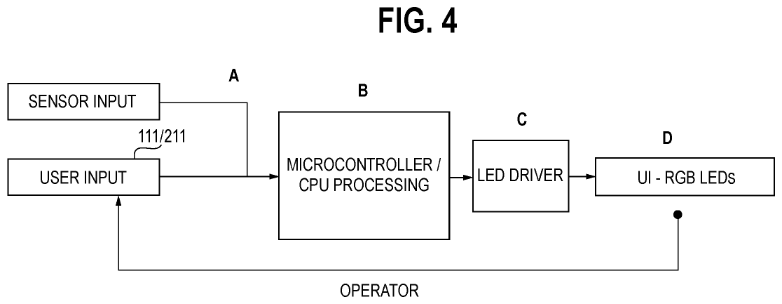

Recognizing the shortcomings of the prior art user interface arrangements, the inventors herein disclose an improved user interface to better interact with a user. FIG. 4 is a simplified operational block diagram of the newly disclosed invention as applied to a business machines inputs and outputs. In some embodiments the operator input 111, and operator input 211 designate where the operator inserts the item to be processed by the machine. The operator inputs and sensor inputs (block A) communicate to Microcontroller/CPU (block B) and depending on the firmware and designated thresholds, communicates to the primary and/or main LED driver (block C) representing the aggregation of a multitude of outputs, the machine's primary communication interface to one main primary location LED UI status indicator (block D) for this embodiment are tricolor RGB types allowing for more emulative and immersive communications purposes. Of note, there is a purposeful continuity communications path from block D to block A where the operator would observe block D outcomes and take it into consideration as they engage with the machine by way of operator input 111 or in an alternative embodiment operator input 211.

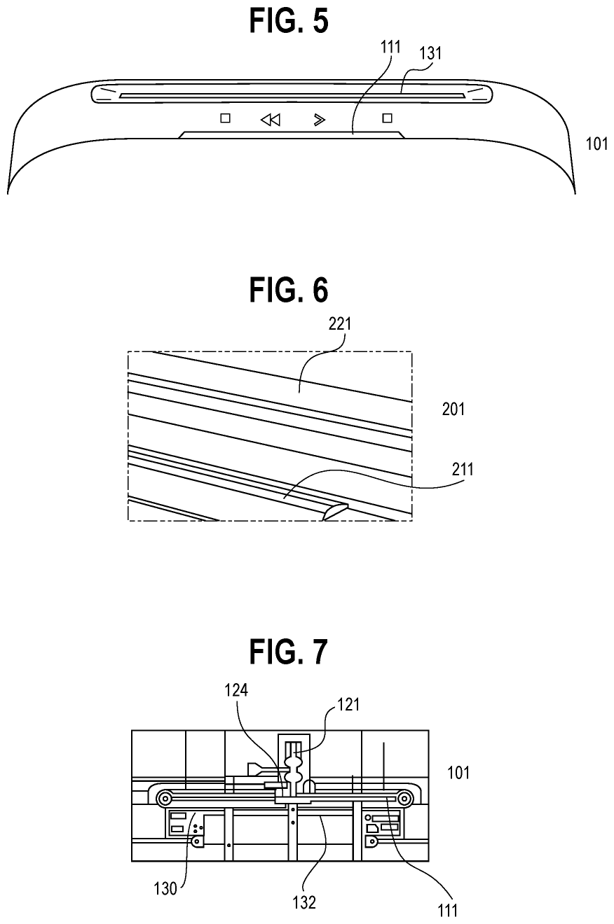

FIG. 5 is a simplified view of the interactive portion of a paper shredder 101 with the disclosed invention as applied to a business machine and embodied within. In some embodiments the operator input entrance 111 is where the operator inserts the paper stacks to be processed by the machine. The UI status indicator 131 in some embodiments is a lightbar consisting of RGB tricolor LEDs which responds to the machines functions and sensors as it processes what has been inserted into the machine by the operator. The UI status indicator 131 thereby creates a communications loop between the machine's signaling and the operator's actions as the operator continues to place paper into the operator input entrance 111 while observing the UI status indication 131. In other embodiments, the status indicator 131 may be a display such as an LCD display capable of displaying characters, indicia, colors, movement, or images.

FIG. 6 is a simplified view of the interactive portion of a document laminator 201 with the disclosed invention as applied to a business machine and embodied within. In some embodiments the operator input entrance 211 is where the operator inserts the lamination pouch containing the item to be processed by the machine. The UI status indicator 221 in some embodiments is a lightbar consisting of RGB tricolor LEDs which responds to the machines functions and sensors as it processes what has been inserted into the machine by the operator. The UI status indicator 221 thereby creates a communications loop between the machine's signaling and the operator's actions as the operator continues to place items to be laminated into the operator input entrance 211 while observing the UI status indicator 221. In other embodiments, the status indicator 221 may be a display such as an LCD display capable of displaying characters, indicia, colors, movement, or images.

FIG. 7 is an interior underside view of the interactive portion of paper shredder 101 of some embodiments. A paper stack is inserted into operator input entrance 111, that action is sensed by IR sensor 124 and thickness sensor 121. The sensors 124 and 121 are in communication with or electrically coupled to PCB 130 and a controller 132. The sensor output values may be then sent by way of a wire harness or other similar structure or means for communicating to PCB 130 of which controller 132 resides upon. In some embodiments, the controller 132 compares the inputs and determines a machine control outcome by way of thresholds and parameters written within its embedded software. Certain actions such as machine wakeup/powerup, motor initiation to start processing the inserted paper stack may be initiated including signaling the machine's action through the disclosed UI.

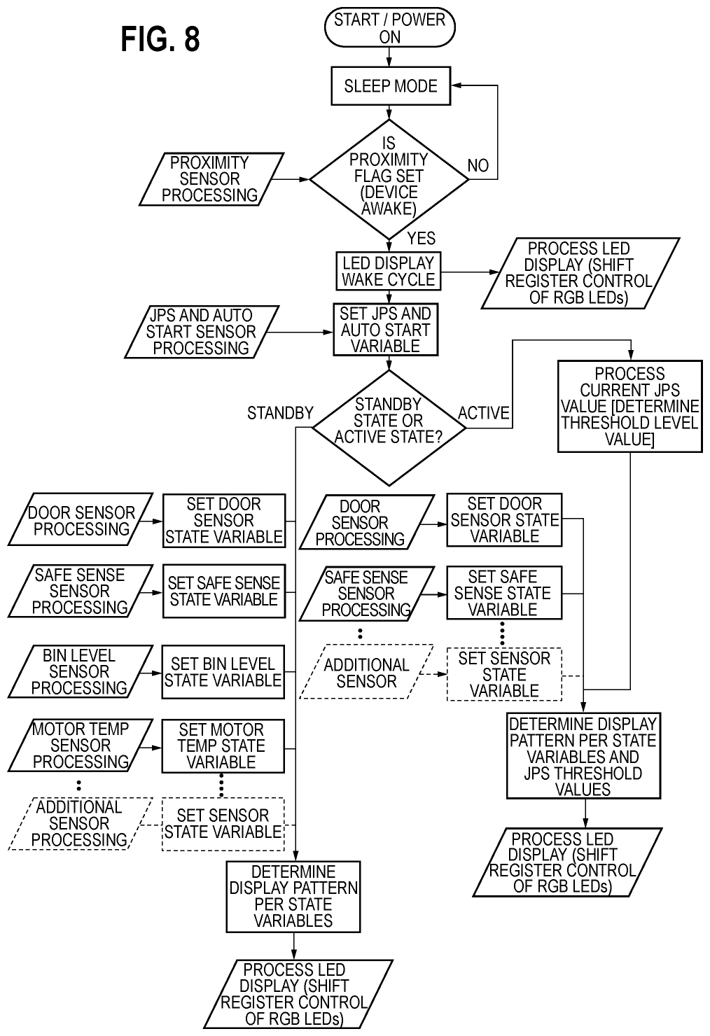

FIG. 8 is a flow chart representing the decision tree actions of the disclosed invention in some embodiments in a paper shredder 101. Controller 132 (not shown in this figure) may include firmware similar to the flow chart shown. The flow chart captures inputs and their outcomes and machine actions, with the machine communicating to the operator through the final action of processing the proper LED RGB signal sequence to the operator.

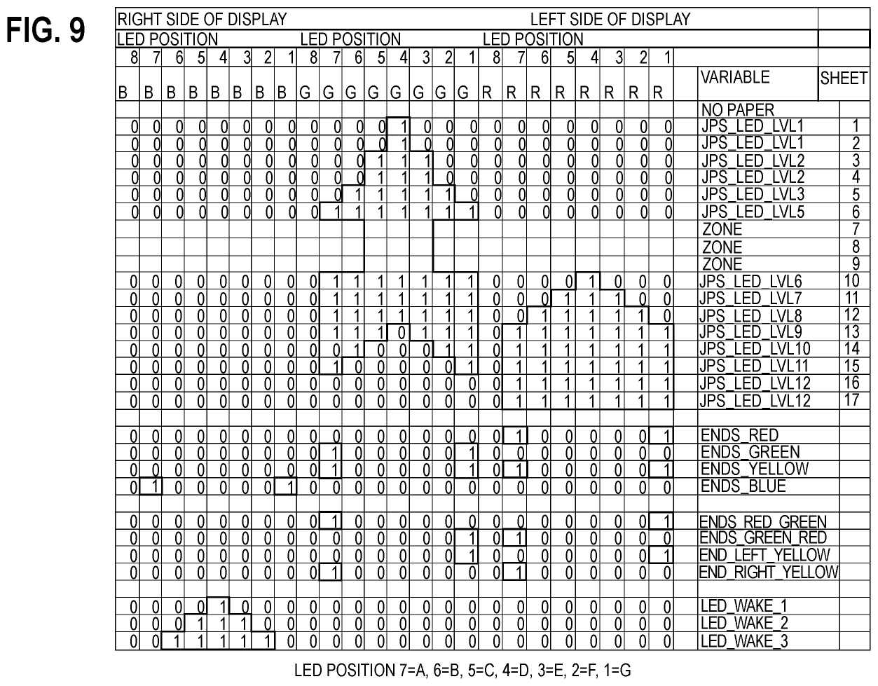

FIG. 9 is a representative chart in which the disclosed invention in one of the embodiments in a paper shredder. The UI includes certain RGB LEDs at positions identified within the chart are emotively activated in the RGB spectrum in response to variable actions as to communicate the machine's state, actions in such a way to the operator to solicit a desired response from the operator. The chart includes the lighting of the LED's of a UI for information provided by the jam proof sensor in response to the number of sheets being presented by the operator. One skilled in the art can see that the LEDs of the UI provides an increasing number of green lights that transition to an increasing number of red lights to indicate the optimum zone for feeding sheets as shown in the chart. The chart also includes the lighting of the LEDs of a UI for information provided to the user upon the triggering of a proximity sensor. The chart also includes the lighting of the LEDs of a UI for information provided to a user to convey the motor temperature status of the shredder. The chart also includes the lighting of the LED's of the UI for information as to the fullness of the bin.

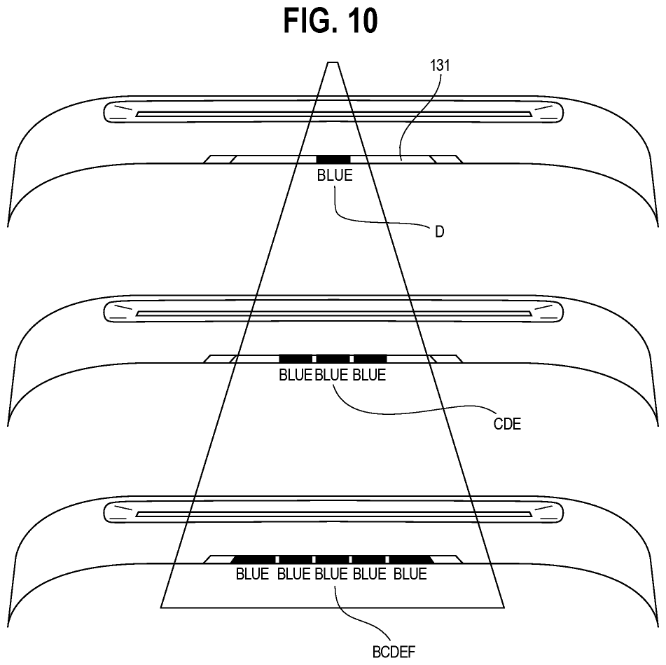

FIG. 10 is a simplified sequential illustration of the interactive portion of a paper shredder 101 of one of the embodiments with the disclosed invention. The UI indicator 131's communication of the machine upon proximity detection is sequentially illustrated. Either upon direct powerup or when a person approaches paper shredder 101, when the proximity sensor senses their proximity to the machine and a predetermined threshold has been activated, the machine wakes up from its sleep state and emotively communicates the change of state through UI indicator 131. The sequence from top to bottom of the figure is shown as the UI indicator 131, in which some embodiments is an LED light bar with a plurality of segments designated A-G, with only B-F being utilized. In the sequence of some embodiments, the lighting of the UI indicator 131 starts from the center position D, increases in intensity and then radiates outwardly eventually encompassing LED positions BCDEF as to signal the machine is now awake and is in the ready state. In the preferred embodiment, the sequence takes approximately 2 to 5 seconds to complete, although the timing may vary as the designer sees fit to encourage the desired interactive behavior of the user or operator. The visual indication can be replaced by or include an audio signal, and/or haptic motion means which can be generated by the machine's main, and/or axillary, and/or specifically design haptic motor initiating a sequence or bursts of action as well.

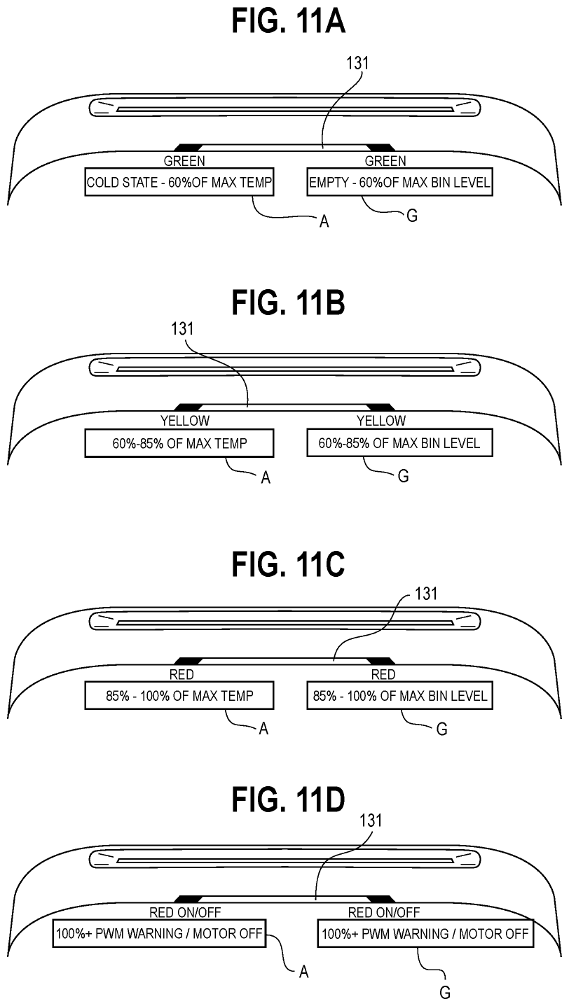

FIG. 11A-D show a simplified sequential illustration of the interactive portion of a paper shredder 101 of one of the embodiments with the disclosed invention as applied. The UI indicator 131's communication of the machine's motor temperature status, for example because of a rise in temperature with increased use, at LED position A and waste bin level status with increased use, at LED position G of UI indicator 131 sequentially illustrated from top to bottom as signaled from controller 132 (not shown) and the LED driver. From research, users sometimes are surprised their operations with the machine are stopped due to machine state. To address that issue, the UI indicator 131 expressively changes state to ensure the operator understands the changes of machine status or state prior to cutting out thereby alleviating the unexpected and sudden stop of processing. Sequential illustrations FIGS. 11A-D shows representative LED position and illumination.

In some embodiments the UI indicator 131 communicates the motor temperature of the machine as it is being used over a range of time until the motor reaches a thermal cut out state. LED position A goes through a gradual sequential color change, from Green, Yellow or Amber to Red to warn of upcoming machine processing stoppage. The final stoppage, represented by the illustration in FIG. 11D, shows the LED position A going through a PWM cycling to create a pulsing Red color to expressively emote the machine is now in a stopped state. The pulse is preferably at a constant rate, but the rate of pulse may increase as the temperature gets closer to the cutoff threshold or point. This pulsing may continue until the motor and/or machine temperature has subsided to an acceptable run temperature, in which case the LED position A would then express an alternative color to coincide with the predetermined threshold value associated with the motor and/or machine temperature detected.

Similarly, LED position G communicates the waste bin level changes of state prior to the final cut out and machine stoppage as represented in FIG. 11D. The PWM cycling expressively emotes in a way as to engage the operator to empty the bin. The machine upon sensing the bin has been emptied, by way of an ambient light detection method, the LED position G would then express an alternative color to coincide with the predetermined threshold value associated with the bin level detected.

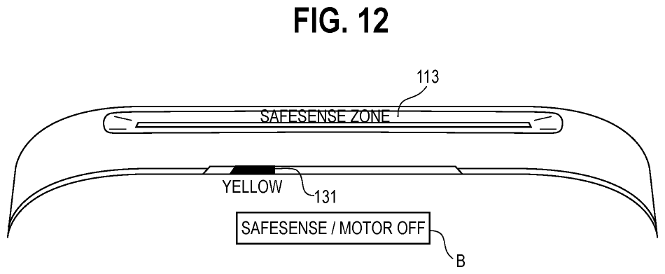

FIG. 12 is a simplified sequential illustration of the interactive portion of an embodiment of a paper shredder 101 with an embodiment of the disclosed invention as applied. The UI indicator 131 communicates the machine's status when proximity sensor 113 is activated. When a predetermined threshold is reached by the signal from proximity sensor 113, the controller 132 (not shown) and the LED driver then signals the LED at position B to an emotive Yellow state and the main motor which actuates the cutting block is in a stop state. The predetermined threshold of the proximity sensor 113 indicates that a person or animal body part is within a predetermined distance from the feed throat of the machine. This ensures a safer condition in which the shredder's motor is switched to an off state when the proximity sensor detects an operator has approached the input entrance or feed throat of the shredder past the recommended operational zone.

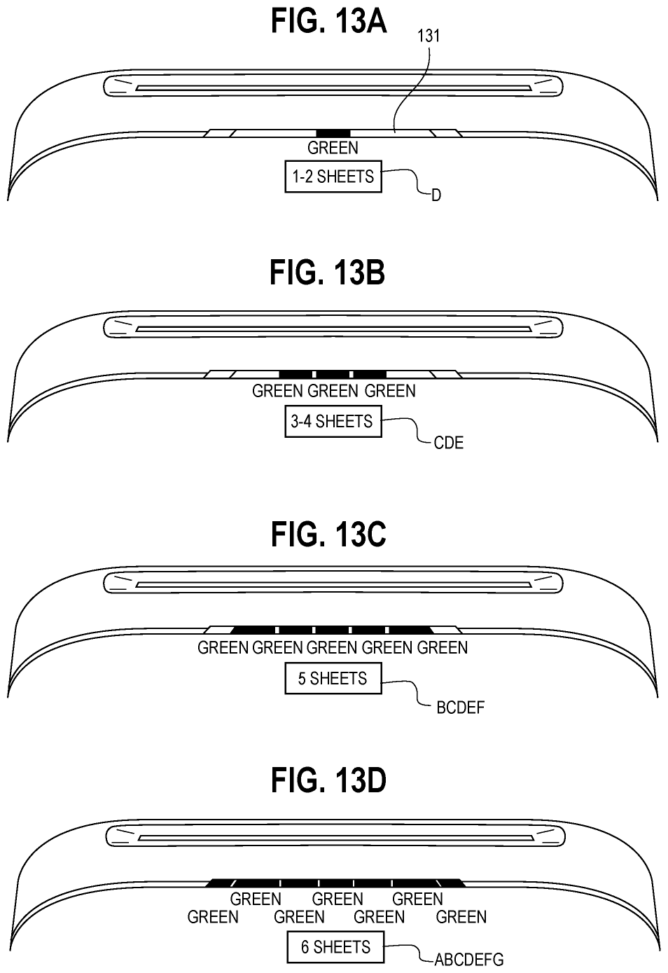

FIGS. 13A-D are a simplified sequential illustration of the interactive portion of a paper shredder 101 with an embodiment of the disclosed invention as applied. The UI indicator 131 communicates the machine's status when thickness sensor 121 (not shown) is activated by placing a paper stack into operator input entrance 111. When predetermined thresholds are reached by the signal from the thickness sensor, the controller 132 (not shown) and the LED driver then signal the LED positions sequentially in FIGS. 13A-D. When a lower count of paper is inserted into the shredder's operator input entrance 111 and thickness sensor 121 senses the lower sheet count LED position D actuates Green. If higher sheet counts of paper are inserted at various times, UI indicator 131 LED positions would correspondingly actuate CDE, then BCDEF and ABCDEF as Green.

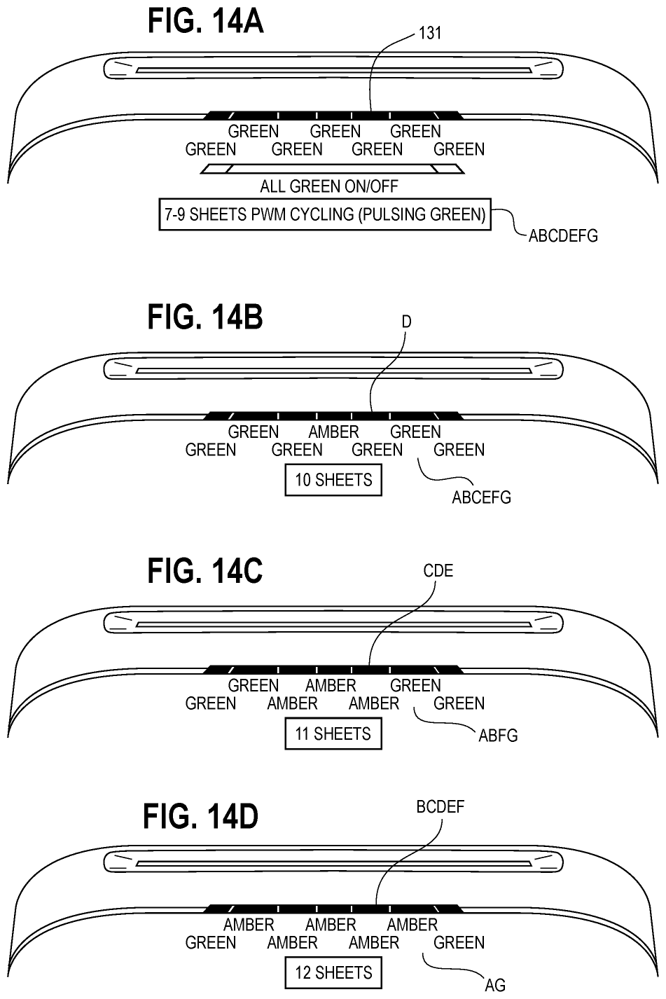

FIGS. 14A-D show a simplified sequential illustration of the interactive portion of a paper shredder 101 with an embodiment of the disclosed invention as applied and a continuation of the sequence shown and described from FIG. 13. The UI indicator 131 communication of the machine's status when thickness sensor 121 (not shown) is activated by placing a paper stack into operator input entrance 111. When predetermined thresholds are reached by the signal from the thickness sensor, the controller 132 (not shown) and the LED driver then signals the LED positions sequentially as illustrated in FIGS. 14A-D. In sequential illustration 14A, when higher sheet counts of 7-9 sheets are inserted into the input entrance 111, the UI indicator 131 LED positions may correspondingly emotively actuate LED segments ABCDEF as Green while going into an PWM cycle as to expressively emote to the operator the machine is now operating in an optimal efficiency state for both the machine and the operator. This optimal threshold is variable depending on the other states of the machine including but not limited to machine operational or motor temperature and bin level.

As shown in FIG. 14B, when the operator inserts a stack thickness just past the optimal threshold thickness, the PWM emotive cycling would halt and the LED position D would then actuate as Amber with the remaining LED position would remain Green. Sequential illustrations FIGS. 14C and 14D show when the operator inserts an even greater amount of paper above the optimal threshold, LED positions CDE and then BCDEF may then signal Amber.

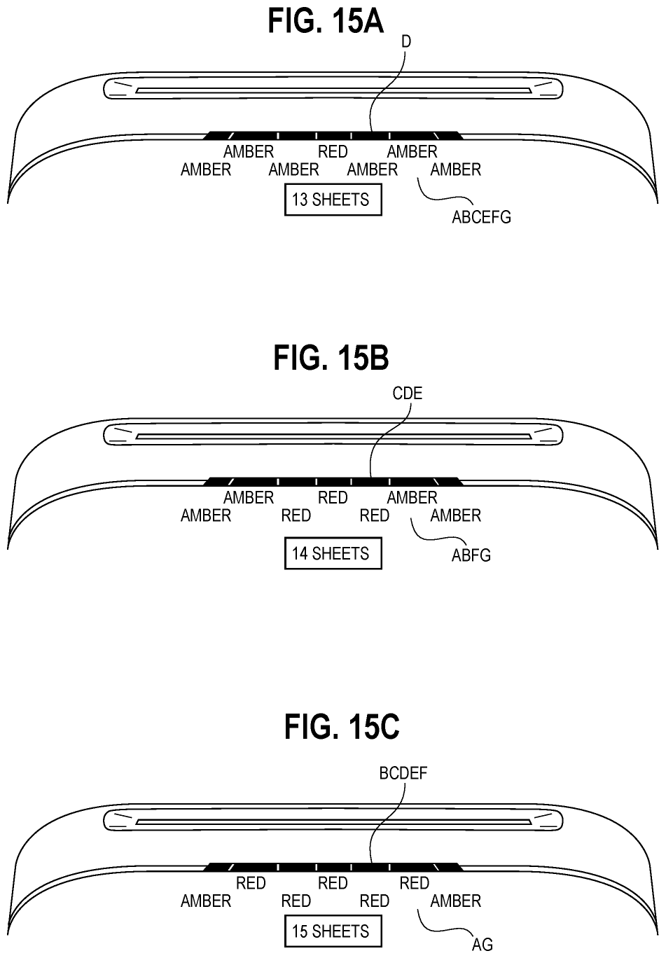

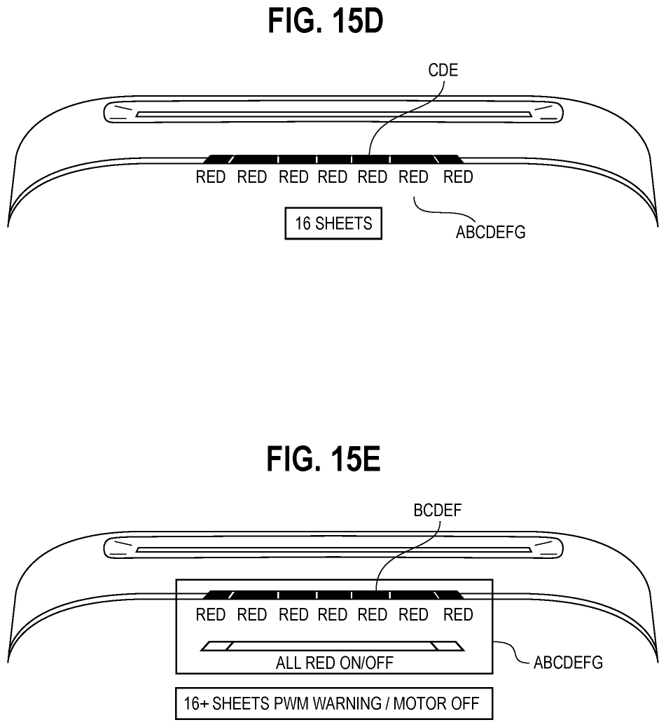

FIGS. 15A-E is a simplified sequential illustration of the interactive portion of a paper shredder 101 of some embodiments of the disclosed invention as applied and a continuation of the sequence shown and described in FIG. 14. The UI indicator 131 communication of the machine's status when thickness sensor 121 (not shown) is activated by placing a paper stack into operator input entrance 111. When predetermined thresholds are reached by the signal from the thickness sensor, the controller 132 (not shown) and the LED driver then signals the LED positions sequentially as illustrated in the sequences of FIGS. 15A-E. In FIG. 15A, when higher sheet count of 13 sheets are inserted, the UI indicator 131 LED positions may correspondingly actuate LED segments ABCEFG as Amber and D as Red. If even higher sheet counts of paper are inserted at various times, UI indicator 131 LED positions would correspondingly actuate, as shown in FIG. 15B, segments ABFG may be illuminated as amber, and segments CDE illuminated as Red. As higher sheet counts are added, the UI indicator 131 may change as shown in FIG. 15C, AG as Amber and BCDEF as Red, and in FIG. 15D, ABCDEFG as Red. As shown in sequential illustration FIG. 15E, when the operator inserts a paper stack thickness just past the machine's upper limit threshold thickness, the PWM emotive cycling would initiate and the LED positions ABCDEFG would then actuate as to expressively emote to the operator the machine is over the operating threshold for the machine while cutting power to the machine's main motor as to prevent it from initiating the shredding cycle, and/or the power to the motor will not be initiated, until the stack of paper is removed from operator input entrance 111. In the FIG. 11-15 illustrative embodiments, the machine's various thresholds can be variable depending on the other states of the machine including, but not limited to, those stated here—machine's rating sheet capacity, operational motor temperature, current parameter, and/or run time, and waste bin capacity.

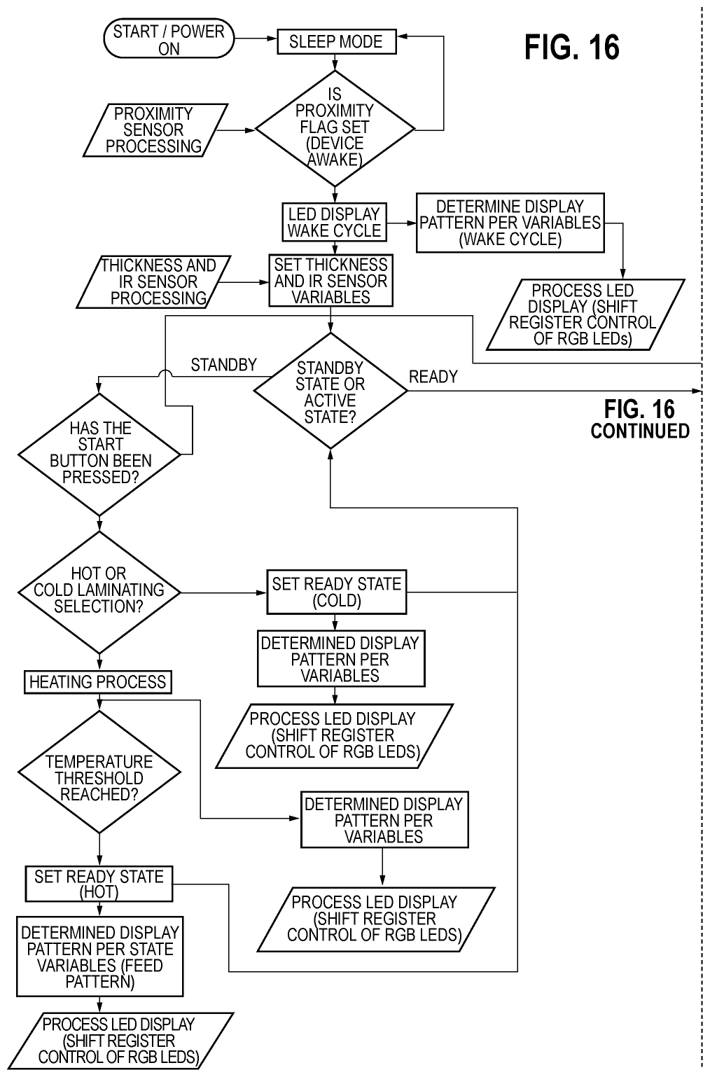

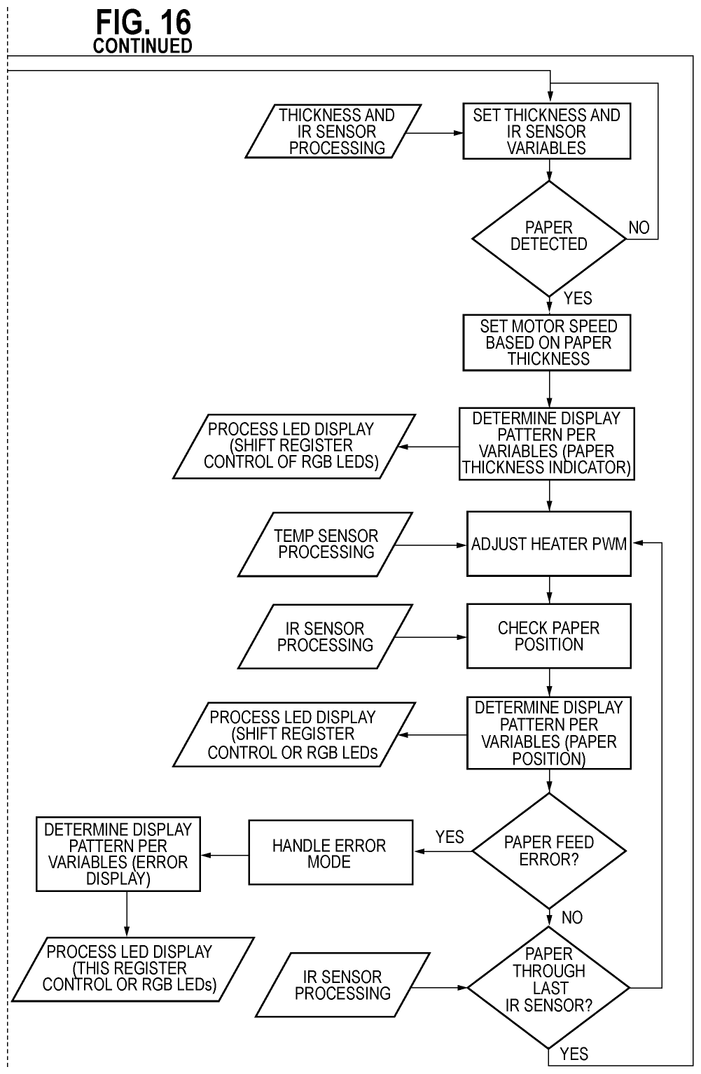

FIG. 16 is a flow chart representing the decision tree actions of some embodiments of the disclosed invention as embodied in a laminator 201. Controller 232 (not shown) embedded software would include firmware similar to the flow chart shown so as to execute the steps of the flow chart. The flow chart captures inputs and their outcomes and machine actions, with the machine communicating to the operator through the final action of processing the proper LED RGB signal to the operator.

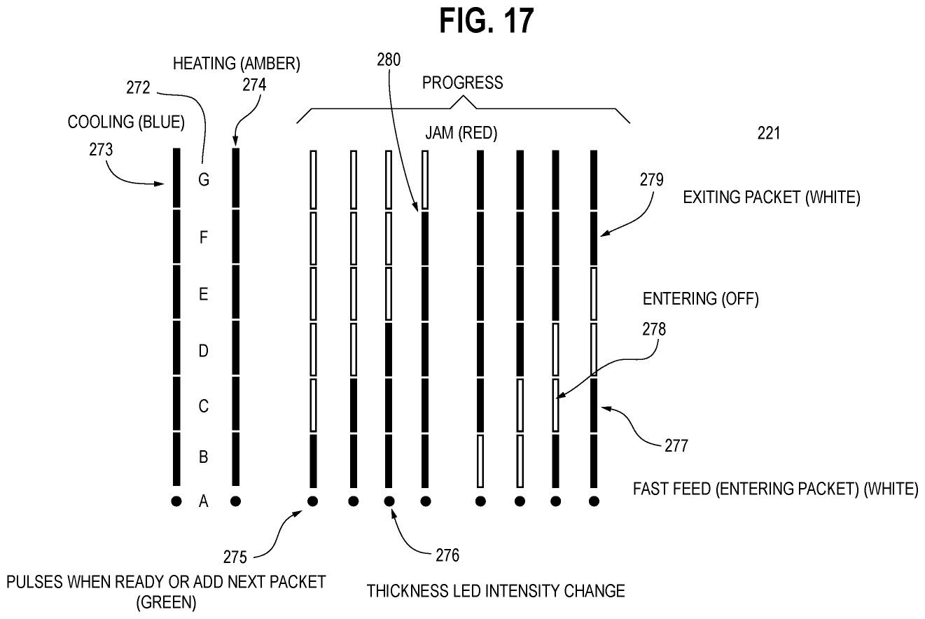

FIG. 17 is a simplified chart representing the interactive UI status indicator 221 of a document laminator 201 (not shown) of an embodiment of the disclosed invention. The UI status indicator 221 in some embodiments is a lightbar or other lighting device that may include RGB tricolor LEDs or other elements which may illuminate and respond to the machine's functions and sensors as it processes what has been inserted into the machine by the operator, thereby creating a communications loop between the machine's interface signaling and the operator's actions as the operator continues to place items to be laminated into the operator input entrance 211 (not shown) while observing the UI status indication 221. LED position indicator 272 illustrates the positioning of the LEDs or segments within the lightbar array, with position A being the designate indicating the first in the sequence with position G being the last position within the lightbar array. Going from left to right in FIG. 17, sequence 273 represents that when the machine is in cooling mode and/or cold laminating mode, all LED positions A-G emote or illuminate (utilizing PWM) a Blue color to show the machine is either cooling and/or is in cold lamination mode. Emoting, as used in this application, may include a pulsing or other cyclical or non-cyclical variation of the illumination intensity or color.

Sequence 274 represents that when the machine is in heating and/or hot lamination mode, all LED positions A-B emote (utilizing PWM) an Amber to Red coloring. Sequence 275 represents when the machine is ready to accept an item into the operator input entrance 211 (not shown). In this embodiment as illustrated, if the UI is in an optional mode in which the LED positions will be utilized to track the progress of the item to be laminated, then LED position A, or alternatively all LED positions, may emotively pulse Green to state the machine is ready and is encouraging the operator to engage with it—that is, to insert the item into the input entrance 211 of the laminator. As soon as the operator inserts an item into the machine, the machine senses the state change and the controller signals LED position B to actuate as White. As the item is tracking through the machine, the progress is represented by successively actuated LED positions as illustrated in FIG. 17 so as to emotively show the processing progress of the item through the machine. Sequence 276 shows such progress by showing LED positions B-D emoting White while LED position A optionally signals the inserted item's thickness and represents thickness by utilizing an emissive intensity—low intensity a thinner item, a higher intensity a thicker, and so on.

If an internal jam within the machine occurs and the machine, by way of a sequential IR sensor not sensing the inserted item passing within a predesignated time threshold as to determine a jam occurrence, as shown in sequence 280, LED position F will emotively pulse Red (utilizing PWM) to let the operator know that a jam occurred at a particular sequential location and a drive motor reverse cycle is being initiated to reverse the item out of the machine, and the progress of the item as represented by the LED progress sequence is reversed and LED positions FEDCBA (as shown) emotes Red sequentially reversed until the jammed item has been fully reversed out the machine. In manual mode machines, the operator must press the reverse actuation switch. As soon as the jammed item has been reversed out of the machine, the LED resumes its normal operations.

Sequence 278 illustrates when the machine has multiple items sequencing through the machine, showing the trailing end 279 of that item as it processes through the machine and the entrance of the newly inserted item front edge 277. Due to the ability to see where the items are in their processing sequence, an operator can confidently insert another item to be processed before the previously inserted item leaves the machine, greatly improving operational efficiency.

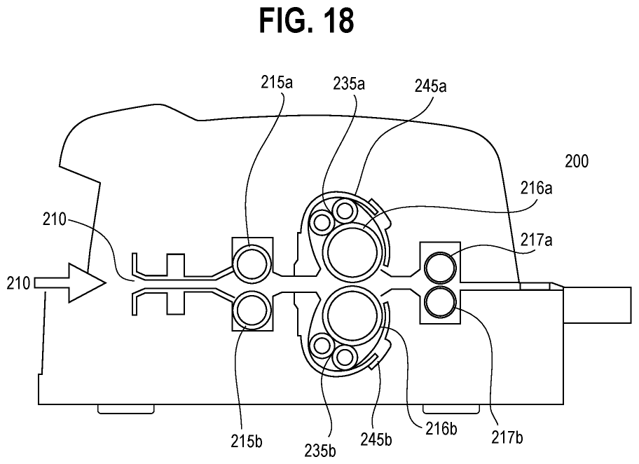

FIG. 18 is a simplified cross-sectional view of a prior art business machine, a document laminator, illustrating the lamination process of the item inserted into the machine and its progression through the machine. An item within lamination pouch 211 is inserted into operator input entrance 210. As upper and lower feed rollers 215a and 215 b feed the item into the heating core within the upper and lower shrouds 245a and 245b, the item enters the upper and lower heat rollers 216a and 216b, which in turn are heated by upper and lower heating elements 235a and 235b liquifying the adhesive layer within the lamination pouch 211. As the item continues through the machine, it enters the upper and lower outlet rollers 217a and 217b, which in turn compresses and cools the pouch and adhesive in a manner to fuse and seal the item within the lamination pouch 211 prior to exiting the machine. Upon exiting the document laminator 200, the lamination process is complete.

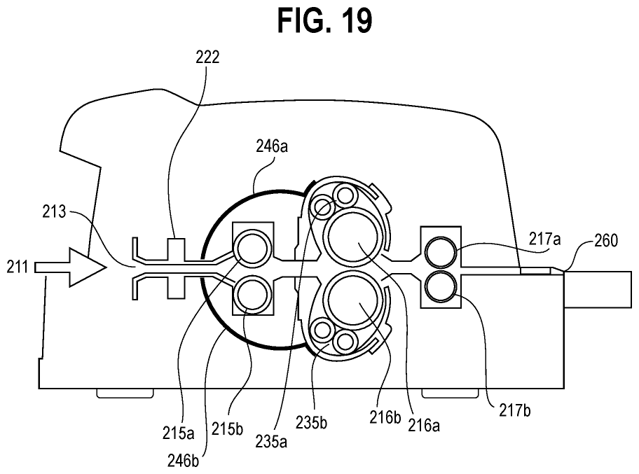

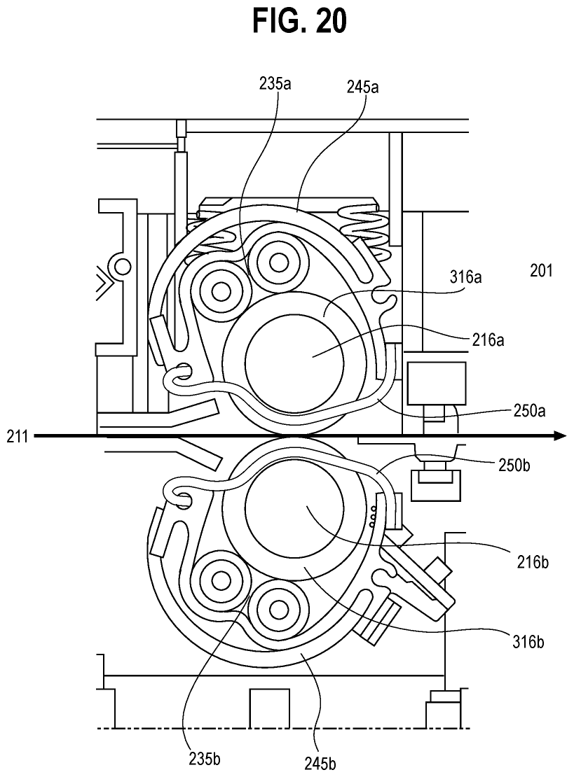

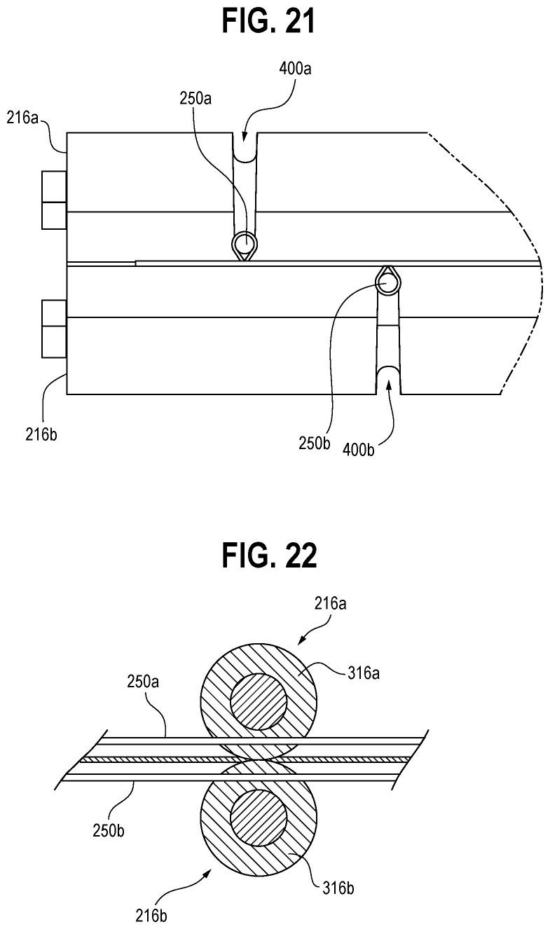

FIG. 19 is a simplified cross-sectional view of a document laminator with a disclosed improved heating core embodied within. Heat retention shrouds 246a and 246b are configured to create a heating core which incorporates feed rollers 215a and 215b along with the main heating rollers 216a and 216b, thereby creating a pre-heating sequence to preliminarily heat the adhesive prior to the final heating and compression rollers. The heat retention shrouds 246a and 246b retain heat and direct heat to the feed rollers 215a and 215b and allow the feed rollers to also act as pre heat rollers, eliminating the need to heat the feed rollers 215a and 215b with their own heat element or source. The objective of this Figure is to illustrate the lamination process of the item inserted into the machine and its progression through the machine until completion. An item within lamination pouch 211 is inserted into operator input entrance 213 which optionally can have an entrance tray which operates as a protective pivoting door when not used as an entrance tray. Thickness sensor 222 is actuated and a value is sent to controller 232 (not shown) which then determines the thickness threshold and the machines actions such as heating and processing parameters. As the inserted item continues, progress sensors such as IR sensors 223 located at a number of locations along the lamination path track the lamination pouch 211 as it engages with the upper and lower feed rollers 215a and 215b, which in turn are preheated by upper and lower heating elements 235a and 235b, while entering into heating cores as defined by upper and lower shrouds 246a and 246b the item enters the upper and lower heat rollers 216a and 216b, which are heated by upper and lower heating elements 235a and 235b to an optimal temperature, thereby liquifying the adhesive layer within the lamination pouch 211. The item continues through the machine entering the upper and lower outlet rollers 217a and 217b which then compresses and cools the pouch and adhesive in a manner as to fuse and seal the item within the lamination pouch 211 prior to exiting the machine.

Upon exiting the document laminator 200, the laminated item now rests on exit tray 260 which optionally functions as pivoting door when not utilized as an exit tray. The entrance and exit tray pivoting doors can optionally open automatically upon machine startup and have single or dual pivoting tray extenders which are hidden when not in use but can be manually and/or can semi-automatically extend when the pivoting action of the flap doors are activated. The front and rear flap door actuation mechanisms can be linked as to function in unison and in addition have an interlock to ensure the machine doesn't operate until the flap doors have been properly engaged as to be in the open position.

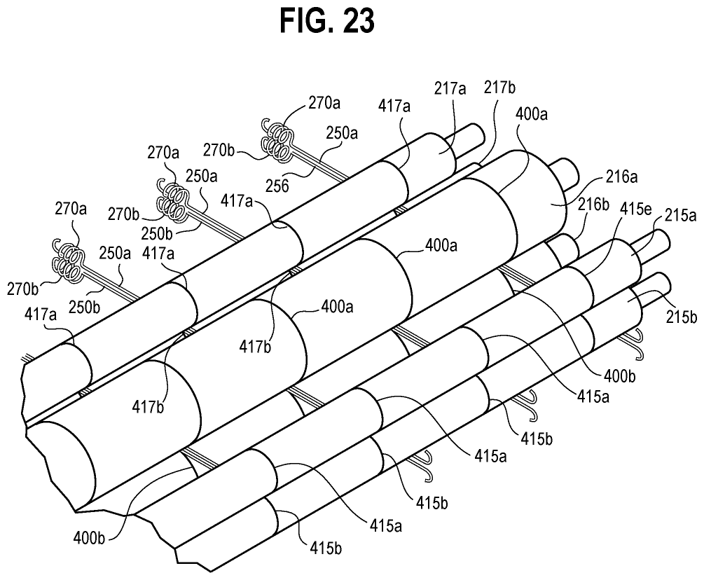

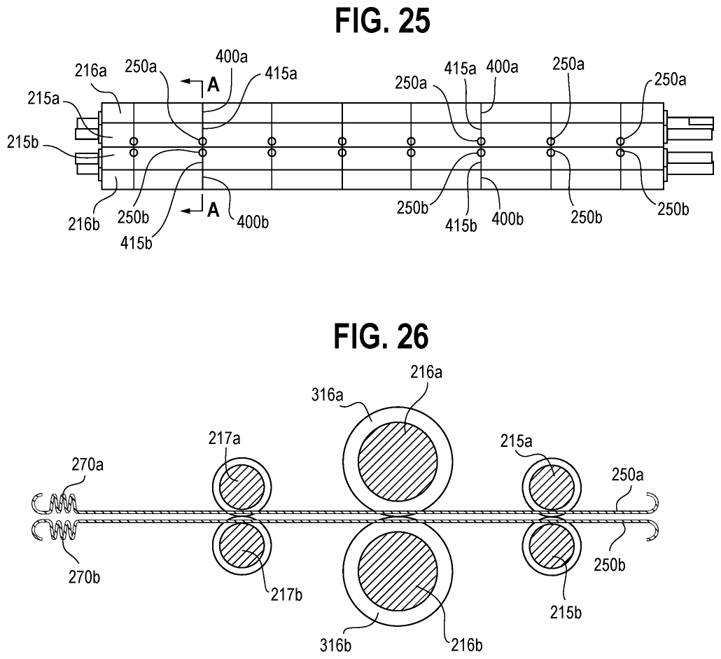

FIG. 20 is a simplified partial machine cross-sectional view of a document laminator with the disclosed anti-wrap feature embodied within. Lamination pouch 211 is inserted into operator input entrance 213 (not shown), eventually entering into heating cores as defined by upper and lower shrouds 245a and 245b. The item enters the upper and lower heat rollers 219a and 219b, which in turn are heated by upper and lower heating elements 235a and 235b liquifying the adhesive layer within the lamination pouch 211. As the item continues processing, there is a tendency for the laminated pouch layers to push the liquified adhesive onto the heated roller and/or a subsequent drive roller if the unit is a multiple roller unit. Due to the adhesive getting onto the rollers, the rollers may become tacky and the lamination film may stick to and follow the roller's surface as the roller rotates, creating a wrap-around effect and a jam situation develops. Further the film can even reach the heating elements 235a or 235b, causing a machine failure at most and at the least, ruin the item being laminated. A smooth radius wire like upper and lower anti-wrap wire or components 250a and 250b, made from a material such as stainless steel, traverses through the outer flexible upper and lower silicone layers 316a and 316b of the heat rollers 216a and 216b, or any rollers, while coming in tangency or near tangency to the heated roller's inner hub. The anti-wrap components 250a and 250b may be assembled in a manner traversing the upper and lower heat rollers 216a and 216b in at least one point or area of at least one of the heat rollers (upper and/or lower), and most preferably in a multitude of points or areas, segmenting the rollers (one or more, drive and/or heated rollers) into two or more sections. Thus, there may be a plurality of such components spaced apart across the rollers as shown in FIGS. 23 and 25. In the most preferred embodiment, the anti-wrap components 250a and 250b or wires are spaced greater than 30 mm apart and are at least three pairs in number. In the most preferred embodiments, the anti-wrap components are made from wire at least 0.005 in diameter, and most preferably 1.0 to 1.5 mm in diameter.

The anti-wrap components 250a and 250b are generally perpendicular to the axis of rotation of the heat rollers 216a and 216b and can be configured to include a spring coil 270a and 270b or other structure allowing the anti-wrap component to stretch on one or both ends of the anti-wrap components 250a and 250b, to ensure proper tracking even when heating and cooling and for ease of assembly. Due to the smooth surface of the wire-like anti-wrap components 250a and 250b and the compressed assembly pressing the upper and lower heat rollers 216a and 216b together with force, the upper and lower silicone layers 316a and 316b of the upper and lower heat rollers 216a and 216b separated by the anti-wrap component then “self-heal” as to close the separated segmentations of the rollers in a manner as to not leave a noticeable mark upon the lamination pouches upon exiting the machine. Such closing or self-healing is shown in FIG. 21.

In some embodiments at least a portion of the anti-wrap components 250a and 250b or wire may reside or track in channels 400a and 400b, slots, cuts, or other defined depressions in the silicone or outer layers 316a or 316b of the heat rollers 216a and 216b. In some embodiments the channels 400a and 400b are circumferential. In some embodiments the channels 400a and 400b, slots, cuts, or other depressions can have a width less than the diameter of the wire-like structures of the anti-wrap components 250a and 250b, allowing the silicone of the heat rollers 216a and 216b to conform and envelope the anti-wrap components or wires. In other embodiments, the channels 400a and 400b, slots, cuts, or other defined depressions width are equal to or greater than the diameter of the anti-wrap components 250a and 250b or wire. The preferred depth for the channels 400a and 400b is 4 times the wire diameter. In other embodiments the depth of the channel is 2 to 6 mm.

Due to the unique properties of the self-healing silicone layers 316a and 316b of the upper and lower heat rollers 216a and 216b, and the smooth surface of the anti-wrap components 250a and 250b or wires creating a “self-healing” segmented surface, the upper and lower anti-wrap components or wires can then be assembled to reside within the same vertical plane, simplifying the manufacturing and assembly requirements by not requiring an alternating assembly pattern for the anti-wrap feature to function properly. Such a vertically aligned arrangement is shown in FIG. 25. In some embodiments, the upper anti-wrap components 250a and the lower anti-wrap components 250b are not vertically aligned, as shown in FIG. 21. In such embodiments, the self-healing portion of the respective silicone layer 316 of the heat roller does not oppose the self-healing portion of an opposing heat roller, such as shown in FIG. 21. Similarly, depressions, channels 400a and 400b, slots, cuts, or other adaptations for accepting the wire-like portions of the anti-wrap components 250 do not align in an opposing fashion with similar depressions channels, slots, cuts, or other adaptations on an opposing roller.

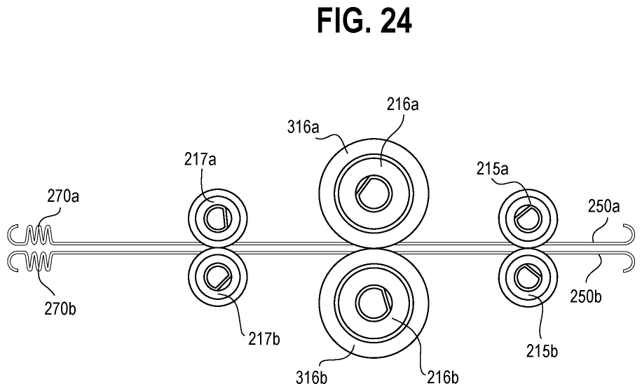

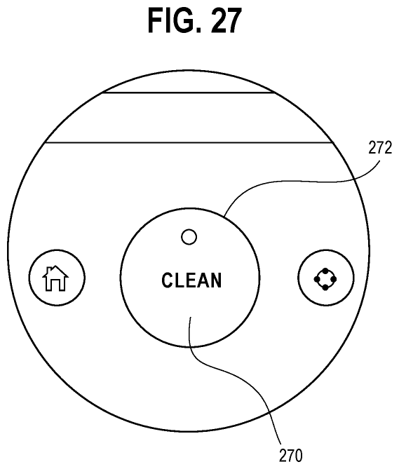

One skilled in the art will recognize that the anti-wrap components described herein can be applied to any rollers in the laminator and need not be restricted to the heating rollers. Such an arrangement is shown in FIGS. 23-26 wherein the anti-wrap components 250a and 250b are interacting with respective channels 415a and 415b in the feed rollers 215a and 215b and respective channels 417a and 417b in the exit rollers 217a and 217b. Due to the disclosed inventive features, pouch and film laminators with this features of the embodiments described herein will not have wrap around catastrophic jams and the lamination pouches will properly exit the unit even when the machine has been poorly maintained.

FIG. 27 is a simplified illustration of a document laminator feature disclosing a cleaning feature. As stated previously and recognized by one skilled in the art or laminators, there is a tendency for lamination machines during the heat and compressing processes to push the liquified adhesive onto the heated roller and/or a subsequent drive roller if the unit is a multiple roller unit. Due to the adhesive getting onto the rollers, a jam situation develops causing a machine failure at most and at the least, ruin the item being laminated. Disclosed herein is a UI which interacts with the machine operator in a manner as to encourage the operator to maintain the machine properly thereby reducing the possibility of terminal failure events. As the laminator is being used over time, LED 272 of interactive button assembly 270 would signal by emotively actuating through a PWM cycle. This emotive cycle is done in a manner as to draw the attention of the machine operator. Observing LED 272 signaling, the operator is then encouraged to engage with the machine as to clean the machine as to turn off the emotive signaling.

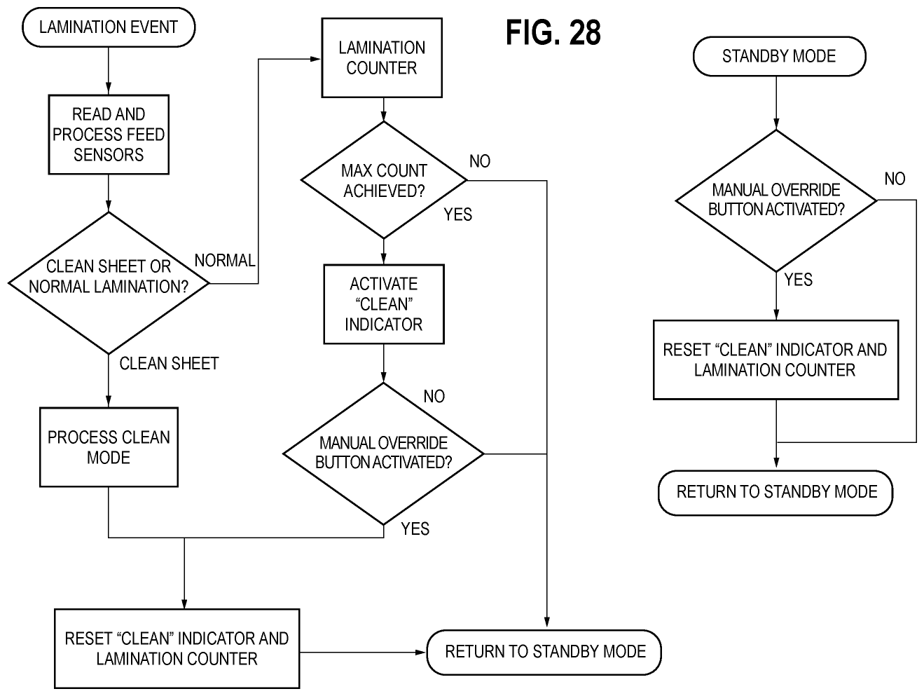

The operational flow of the cleaning sheet operation is shown in FIG. 28.

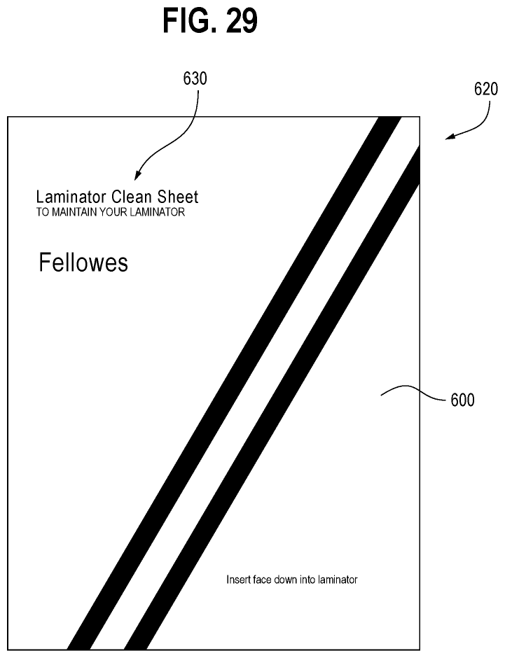

The cleaning process can be accomplished by the use of a cleaning sheet 600, shown in FIG. 29. Placing the cleaning sheet 600 into the machine, the sensor within the disclosed machine can recognize the inserting of the cleaning sheet 600 by way of the sequential IR sensors in communication with a controller and/or by way of the thickness sensor through a series of printed and/or thickness patterns on the surface of the cleaning sheet configured in a manner as to allow multi directional insertion of the cleaning sheet (landscape or portrait).

In some embodiments the cleaning sheet 600 may include a diagonally placed code 620. The diagonally placed code 620 may be a simple pattern, a bar code, QR code, or other indicia that may interact with a sensor, such as an IR sensor or sensors such as those previously discussed. In the preferred embodiment, the diagonally placed code 620 includes a 0.5 inch wide dark bar separated by a 0.75 inch light bar from a 0.75 inch dark bar. The cleaning sheet 600 may include authenticating indicia 630 to confirm that the cleaning sheet meets the quality standards of the machine manufacturer. Such authenticating indicia may include a bar code, text, QR code, trademark, or any other text or symbols that is readable by sensors in the machine. In some embodiments the code or indicia is detected by and exit sensor. In some embodiments the code is detected by a thickness sensor 222 or IR sensor 223, preferably proximate to the input entrance 210 or feed slot. The signal from the appropriate sensor is sent to a controller 232. In some embodiments the controller 232 includes firmware to execute the steps for the cleaning as outlined in FIG. 28. Once the machine detects the cleaning sheet 600 has been fully processed by the machine, LED 272 may stop the emotive actuation and the machine controller would then resume the timing cycle until the next threshold is triggered initiating the sequence once again.

If the machine fails to recognize the cleaning sheet properly, or as to save costs, or the IR and/or thickness sensors are not utilized, or a non-certified cleaning sheet is used, the operator in those cases may manually actuate the button assembly 270 to let the machine know that the cleaning operation was initiated and completed. Such action may be interpreted by the controller or other logic withing the machine to stop the emotive action and resume the timing cycle for cleaning until the next threshold is triggered initiating the sequence once again.

The foregoing disclosure of specific embodiments is intended to be illustrative of the broad concepts comprehended by the invention.

1. A shredder having an input entrance for inputting material for shredding, a bin for receiving shredded material, a machine status display located proximate to the input entrance, a thickness sensor to sense the thickness of material placed in the input entrance, a bin level sensor, a motor temperature sensor, a controller for receiving inputs from the thickness sensor, the bin level sensor, and the motor temperature sensor, the controller being in communication with the status display, the controller determining the optimal thickness of material for placement in the input entrance, the status display communicating whether the material placed in the input tray is of an optimal thickness for shredding.

2. The shredder of claim 1, wherein the display communicates a first signal to indicate the material is of a less than optimal thickness, communicates second signal to indicate the material is of an optimal thickness, and communicates a third signal to indicate the material is in excess of an optimal thickness.

3. The shredder of claim 2, wherein the display is an array of LEDs arranged parallel to the input entrance, the display pulsing to indicate the material is of optimal thickness.

4. The shredder of claim 1, wherein the display pulses to communicate the shedder is operating at optimal efficiency.

5. The shredder of claim 1, wherein the display is an array of LEDs arranged in parallel to the input entrance, the LEDs lighting sequentially in sequences to communicate to the operator whether the material is of an optimal thickness.

6. The shredder of claim 5, wherein the display lights an increasing number of LEDs as the thickness of material increases to the optimal thickness.

7. The shredder of claim 3, the shredder including a proximity sensor to sense when an operator is in proximity of the shredder, the proximity sensor communicating with the controller, the controller waking the shredder for operation when an operator is sensed by the proximity sensor, the controller communicating with the display to communicate with the operator that the shredder is ready for receiving material.

8. The shredder of claim 7, wherein the controller communicates with the display to signal to the operator to reduce the thickness of material when the motor temperature sensor exceeds a threshold level.

9. A shedder for shredding material, the shredder including an input slot for inputting material into the shredder, a plurality of sensors, a controller for receiving inputs from the sensors, a display in communication with the controller, the display conveying information on the shredder status to an operator, the sensors including a proximity sensor, a bin level sensor, a motor temperature sensor, and a thickness sensor, the controller evaluating the inputs from the plurality of sensors, the display displaying a first signal on the display when an operator is in proximity to the shredder, displaying a first sequence of signals when a less than optimal thickness of material is placed in the input slot, displaying a second sequence of signals when an optimal thickness of material is placed in the input slot, displaying a third sequence of signals when material of a thickness greater than an optimal thickness is placed in the input slot.

10. The shredder of claim 9 where the display is a plurality of LEDs positioned parallel to the input slot, the first sequence of signals being a progression of lighted LEDs, the number of lighted LEDs increasing as the thickness of material increases.

11. The shredder of claim 10 where the second sequence of signals is a pulsing of lighted LEDs.

12. The shredder of claim 11, where the third sequence of signals is a progression of lighted LEDs changing from a first color to a second color.

13. The shredder of claim 12, where the first signal is a lighted LED, the LED lighted in a third color.

14. A shedder for shredding material, the shredder including a input slot for inputting material into the shredder, a plurality of sensors, a controller for receiving inputs from the sensors, a display in communication with the controller, the display conveying information on the shredder status to an operator, the sensors including a proximity sensor, a bin level sensor, a motor temperature sensor, and a thickness sensor, the controller evaluating the inputs from the plurality of sensors, the controller determining display patterns for the display to convey machine state information to an operator, the display patterns including a first display pattern to communicate the shredder is on and ready for input, a second display pattern to communicate the shredder can accept an increase in material in the input slot, a third display pattern to communicate the shredder is receiving an optimal amount of material in the input slot, and a fourth display pattern to communicate the shredder is approaching a shut-down condition.

15. The shredder of claim 14, the display patterns being displayed on an LED display located parallel and proximate to the feed slot, the LED display including a plurality of colors.

16. The shredder of claim 15, the first display pattern including a plurality of LEDs lighting in the color blue in an increasing number, the pattern repeating when the number reaches five.

17. The shredder of claim 15, the second display pattern including a plurality of lighted segments, the number of segments lighted increasing in number as an amount of material placed in the input slot nears the optimal amount of material.

18. The shredder of claim 14, the third display pattern including a plurality of lighted segments, the lighted segments pulsing.

19. The shredder of claim 14, the controller evaluating inputs from the motor temperature sensor and the thickness sensor to select the display pattern to display.

20. The shredder of claim 14, the controller evaluating inputs from the bin level sensor, the thickness sensor, and the motor temperature sensor in determining an optimal thickness of material the shredder should accept.
